(19) United States
(12) Patent Application Publication
(10) Pub. No.: US 2024/0162456 A1
(43) Pub. Date: May 16, 2024

(54) Solid Oxide Fuel Cell with Integrated Heat Use

(71) Applicant: Hall Labs LLC, Provo, UT (US)

(72) Inventors: David R. Hall, Provo, UT (US); Scott Woolston, Springville, UT (US); Huntington Tracy Hall, Provo, UT (US); Michael Hall, Provo, UT (US); Miguel Lazaro, Provo, UT (US); Tyler Thomas, Salt Lake City, UT (US); Jeff Duncan, Tucson, AZ (US); Cole Cecil, Provo, UT (US)

(73) Assignee: Hall Labs LLC, Provo, UT (US)

(21) Appl. No.: 18/509,182

(22) Filed: Nov. 14, 2023

Related U.S. Application Data
(60) Provisional application No. 63/383,668, filed on Nov. 14, 2022.

(51) Int. Cl. H01M 8/04014; H01M 8/0267; H01M 8/0668; H01M 8/22

(52) U.S. Cl. CPC H01M 8/04014; H01M 8/0267; H01M 8/0668; H01M 8/22; H01M 2008/1293

(57) ABSTRACT

There is described a system for producing electrical energy and utilizing associated heat. The system includes a source of fuel, a source of oxygen and a solid oxide fuel cell configured to oxidize the fuel to create electrical energy and heat. The system also includes at least one unit configured to utilize heat generated by the solid oxide fuel cell. This at least one unit is selected from the group consisting of: a solid waste pyrolysis unit; a hydrothermal carbonization unit; a water distillation unit; a water pasteurization unit; a water heating unit; a room heating and cooling unit; and a biomass drying unit. In a second aspect, the invention is a system for providing utilities used in a multi-residence complex.

### CROSS-REFERENCE TO RELATED APPLICATION

The present application is a continuation-in-part of U.S. Provisional Patent Application No. 63/383,668, filed Nov. 14, 2022, entitled “Solid Oxide Fuel Cell with Integrated Carbon Capture.” The entire disclosure of this prior application is incorporated herein by this reference.

### TECHNICAL FIELD

The invention relates to the field of fuel cells, particularly Solid Oxide Fuel Cells (SOFC) integrated with other utilities.

### BACKGROUND

A solid oxide fuel cell (SOFC) is an electrochemical device that produces electricity by oxidizing a fuel. Generally, fuel cells are characterized by their electrolyte material. SOFC's have a solid oxide or ceramic electrolyte. SOFC's provide advantages including a relatively low cost, high combined heat and power efficiency, low emissions, long-term stability, and fuel flexibility. One disadvantage is the high operating temperature which can require longer start-up times and can cause mechanical and chemical compatibility issues. Another issue is that many SOFC's use steam reformed methane as fuel to produce the hydrogen to operate the SOFC. This is an efficient and economical process. However, it produces CO₂ as a byproduct, with attendant environmental effects.

### SUMMARY

In a first aspect, the invention is a system for producing electrical energy and utilizing associated heat. The system includes a source of fuel, a source of oxygen and a solid oxide fuel cell configured to oxidize the fuel to create electrical energy and heat. The system also includes at least one unit configured to utilize heat generated by the solid oxide fuel cell. This at least one unit is selected from the group consisting of: a solid waste pyrolysis unit; a hydrothermal carbonization unit; a water distillation unit; a water pasteurization unit; a water heating unit; a room heating and cooling unit; and a biomass drying unit.

In a second aspect, the invention is a system for providing utilities used in a multi-residence complex. The system includes a source of fuel, a source of oxygen, and a solid oxide fuel cell configured to oxidize the fuel to create electrical energy for use in the complex, and to create heat. The system also includes at least one unit configured to provide a utility other than electrical energy to the complex and to utilize heat generated by the solid oxide fuel cell. This at least one unit is selected from the group consisting of: a solid waste pyrolysis unit for treating solid waste generated by residents of the complex; a hydrothermal carbonization unit for treating black water generated by residents of the complex; a water distillation unit for distilling gray water generated by residents of the complex; a water pasteurization unit for pasteurizing water for use in the complex; a water heating unit for providing hot water for residents of the complex; a room heating and cooling unit for providing heating and cooling for at least a portion of the complex; and a biomass drying unit for drying biomass generated either by residents of the complex, by outside producers, or by both.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative, are not intended to limit the scope of claimed inventions, and are not intended to show every potential feature or embodiment of the claimed inventions. The drawings are not necessarily drawn to scale. In some instances, certain elements of the drawing may be enlarged with respect to other elements of the drawing for purposes of illustration.

FIG. 1 is a schematic diagram of the system integrated a SOFC with other units that make use of the heat and CO₂ produced by the SOFC.

FIG. 2 is a top perspective view of a multi-residence complex employing the integrated system.

FIG. 3 is a side view of the complex of FIG. 2.

FIG. 4 is a view of the conduits, pipes and tanks of the integrated system.

FIG. 5 is a schematic view of an integrated system using a heat exchange manifold.

FIG. 6 is a partial, cross-sectional view of one embodiment of a heat exchange manifold.

FIG. 7 is a partial, cross-sectional view of another embodiment of a heat exchange manifold.

FIG. 8a is a schematic view of a biomass waste pyrolysis unit.

FIG. 8b is a schematic view of the biomass waste pyrolysis unit, showing biochar produced therein.

FIG. 9a-9d are schematic views of a hydrothermal carbonizations unit at various stages in the process.

FIG. 10 is a schematic diagram of a multi-effect distillation unit.

FIG. 11 is a schematic diagram of an alternative multi-effect distillation unit.

FIG. 12 is a schematic diagram of another alternative multi-effect distillation unit.

FIG. 13 is a schematic diagram of a pasteurization unit.

FIG. 14 is a schematic view of a water heating unit.

FIG. 15 is a schematic view of a distributed heat sink for heat pumps in individual residences.

FIG. 16 is a schematic view of an embodiment of biomass waste drying unit.

FIG. 17 is a schematic view of another embodiment of a biomass waste drying unit.

FIG. 18 is a perspective view of a block made from dried biomass.

FIG. 19 is a cross section of the block of FIG. 18.

FIG. 20 is a baled mass of dried biomass.

FIG. 21 is a schematic view of a simplified greenhouse, using exhaust from the SOFC for CO₂ enhancement and for heat.

FIG. 22 is a schematic view of a waste plastics melting unit.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “SOFC” is meant to refer to a solid oxide fuel cell.

Unless otherwise indicated, percentages are given as percentages by weight.

### Overview of the Integrated System

One goal of the integrated SOFC utility system is to provide all of the utility needs for a single building, including electrical, water, and sewer needs. The SOFC directly provides the electrical needs through its normal operation. However, current designs for SOFCs are approximately 50% efficient. While significantly higher than normal combustion based electrical sources, a large amount of power is lost thermally through the exhaust gasses. As mentioned above, the SOFC has a very high operating temperature. The exhaust gas exits, as a results, at very high temperatures, typically greater than 600° C. Not only is the exhaust gas carrying large amounts of power, it is doing so via high quality heat. The integrated system harnesses this heat to provide waste treatment, water treatment, HVAC, and additional carbon use and capture.

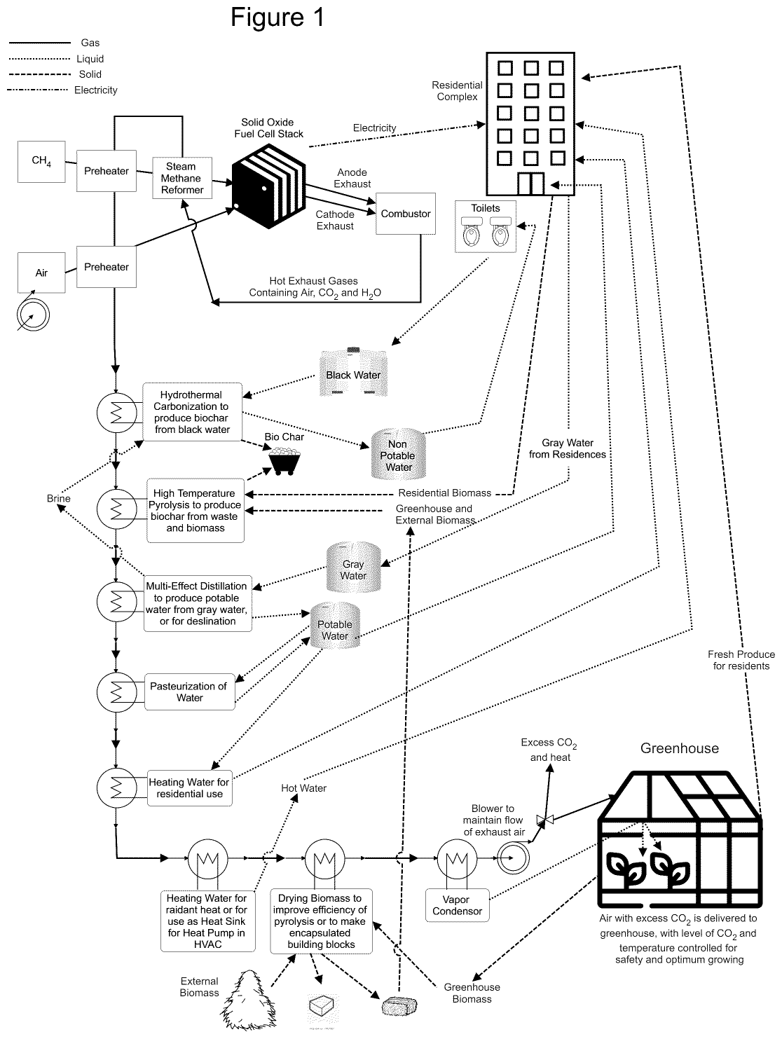

FIG. 1 is a schematic diagram of the entire system, where solid lines are used to represent a gas flow, dotted lines are used to represent liquid flow, dashed lines are used to represent a flow of solids, and a dashed/dotted line is used to represent flow of electricity. For convenience in explaining the integration of the system, FIG. 1 is laid out simply with the various units in series, each taking heat from the exhaust in its turn. Nevertheless, note the discussion below that explains more efficient and effective designs for capturing and using the heat from the SOFC exhaust.

As shown, the system includes inputs for fuel, preferably methane or natural gas, and for air. The air is usually fed with the assistance of a blower. A preheater is set up for the methane input and the air input. Preferably, these preheaters are heated by the heated exhaust from the SOFC. The methane stream also passes through a steam reformer, wherein at least a portion of the methane is converted to H₂ CO and CO₂. The Steam Methane Reformer (SMR) is discussed in more detail below. It is noted here that the SMR also uses heat from the SOFC exhaust.

As discussed in more detail below, the SOFC takes the H₂ from the SMR and the O₂ from the air and produces electricity. It also produces a hot exhaust that includes air, water vapor, and CO₂. Preferably, the electricity is used to supply all of the needs for a multi-residence complex. To satisfy the needs during peak times and to take electricity during low demand times, the system may be attached to a larger electrical grid. However, it is preferred that the system be able to handle peak demands and to keep running during low demand times. This can be accomplished by feeding more and less fuel to the SOFC. This can also be accomplished by providing conventional large batteries for charging during low demand times and for discharging during peak times. Alternatively, other means for storing and releasing energy may be used. For example, a tank of water may be heated during low demand times and then that energy from the heated water can be used during peak times. Also, it is preferred that the electric power generation and usage be controlled through a digital system that predicts and anticipates loads and shifts some operations to off peak times. For example, the system may be programmed to run certain appliances, such as washers and dryers, during off peak times. Also, large batteries, such as for electric vehicles, may be charged during off peak times.

The exhaust from the SOFC's anode and electrode exits the SOFC and is fed into a combustor, described in more detail below. Preferably, the exhaust also includes a stream of air that was passed over the SOFC to take away any radiant heat from the SOFC. As mentioned, this stream is hot, typically between 600 and 1000° C. This stream includes includes air, water vapor, and CO₂.

After providing heat to the SMR and the two preheaters, the SOFC exhaust passes a heat exchanger that takes heat to run a hydrothermal carbonization (HTC) unit. This HTC unit is discussed below, but basically uses heat from the SOFC exhaust to convert blackwater and other liquid organic waste products into biochar. Preferably, this HTC unit is configured to handle all of the blackwater, i.e. sewer lines, from the complex. The system preferably includes a holding tank for the blackwater and can schedule operation throughout the day to use energy most efficiently. The biochar produced is discussed in more detail below, but suffice it to say here that it is a good form for sequestering carbon. The water released from the HTC unit is not potable, but is preferably fed back to supply flush water for the toilets in the complex.

Shown next in FIG. 1 is a high temperature pyrolysis unit for converting solid waste, preferably biomass waste, into biochar. This unit is also described in more detail below, but suffice it to say here that it is also a good way to sequester the carbon from this biomass waste. Preferably, all of the residential biomass from the complex is fed into this unit. Also, it is preferable to design this unit to process biomass created outside of the complex. For example, biomass can be brought in from local farms, gardens, and landscape services for processing. In this way, the carbon sequestration by the system is multiplied. As depicted further down the line in FIG. 1, it is preferred to dry the biomass before feeding it to the pyrolysis unit.

Shown next in FIG. 1 is a multi-effect distillation (MED) unit. This unit is capable of taking gray water from the complex, distilling it and making it potable, i.e. drinkable. Preferably, the system includes a gray water storage tank. As described in detail below, the MED uses heat efficiently, but does take heat from the SOFC exhaust to drive the first “effect.” The brine produced by the last effect can be fed to the HTC unit. The distilled water may be sent through the pasteurization unit described next, and may be used to provide water to the water heating unit, described after that. Also, if the geography or climate call for it, the MED unit may be used as a desalination unit to produce drinking water from sea water.

Next in FIG. 1 is a pasteurization unit. This unit is used as needed to sanitize the potable water, by killing any microorganisms in the water by heat. As described below, in the present system, the heat is provided by the SOFC exhaust.

The next unit in FIG. 1 is the water heating unit. This unit provides hot water for the residents in the complex. Hot water can be used for bathing and use in certain appliances. As will be discussed below, the energy to heat the water comes from the SOFC exhaust.

As shown next in FIG. 1, a unit is included for heating water to be used in heating and cooling systems (HVAC). The system may heat water for use in a radiant heat system. However, more preferably, a supply of water is heated for use in a heat pump driven HVAC system and/or in an absorptive cooling system. Preferably, each residence in the complex has individual units that can be controlled to run heating or cooling. These individual units will be supplied electricity from the SOFC but will use a reservoir of water for the heat sink. This water can be heated by the SOFC exhaust. This water can also be cooled by absorptive cooling.

As seen in FIG. 1, the next unit in the most preferred system is a biomass drying unit. This unit may be heated by a heat transfer fluid that has picked up heat from the SOFC exhaust. Alternatively, it may be heated directly by passing the SOFC heat exhaust through the biomass to dry it. As will be discussed below, drying the biomass can help the pyrolysis unit run more efficiently. The biomass for drying preferably comes from the complex. In addition, it is preferred to obtain biomass from other sources, such as local gardens, greenhouses, farms and landscapers. Also, after drying, the biomass may be baled or pelletized for ease in transport and storage. It may also be made into blocks, preferably encapsulated in recycled plastics, for various uses.

At some point in the system, it is desirable to condense the water vapor from the SOFC exhaust. This water comes from the reaction of H₂ and O₂ in the SOFC. As shown in FIG. 1, the water vapor may be condensed just before the greenhouse and the water is used to water plants in the greenhouse.

As depicted in FIG. 1, it is preferable to include fans or blowers to maintain flow of the SOFC exhaust.

At the end of the line for the SOFC exhaust is a greenhouse, wherein the excess CO₂ in the exhaust can be used for CO₂ enhancement to improve growing in the greenhouse. Preferably, the SOFC exhaust can also be used to heat the greenhouse. Preferably, the greenhouse provides fresh produce to the residents of the complex. As explained below, the level of CO₂ and the temperatures are carefully monitored to ensure the safety of workers in the greenhouse and optimum growing conditions for the plants in the greenhouse. If all of the SOFC exhaust is not needed in the greenhouse, a valve is opened to vent the SOFC exhaust to the environment.

In concluding the discussion of FIG. 1, it is again noted that the system is depicted in a simplified manner. The various units are discussed below in greater detail, as is the design of heat transfer devices that greatly improve the design and operation of the system.

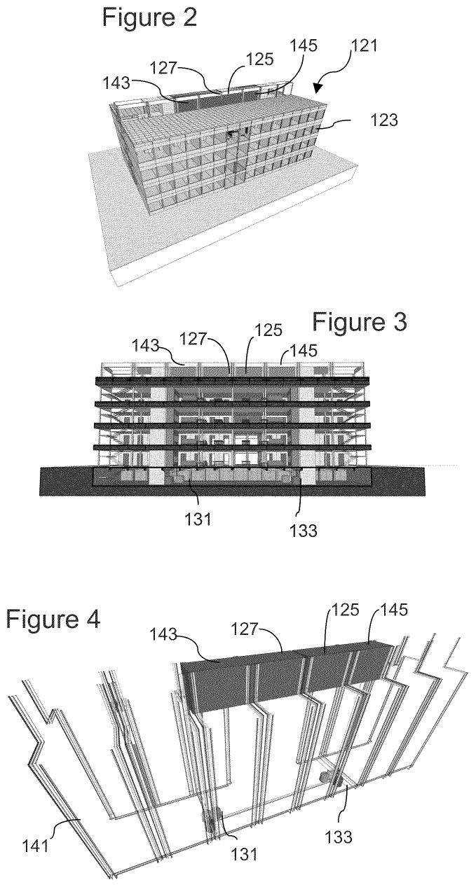

FIG. 2 is a perspective view of a multi-residence complex 121. The complex is made up of individual residences 123. On top of the complex are two utility rooms 127 and 125. Each of these rooms houses an SOFC stack and attendant structures. As noted above, it is preferable to have two identical units for each complex, so that there is a failsafe backup if one of the units goes down. This also allows one unit to be taken offline for maintenance without interrupting power and other utilities to the complex. Auxiliary rooms 145 and 147 may hold additional hardware for the integrated systems, such as pumps, heat exchangers, tanks, etc.

FIG. 3 is a side view of the complex of FIG. 2, including a cutaway to show the basement space. As can be seen, large water tanks 131 and 133 are located in the basement. Some tanks are for blackwater, while others are for gray water, and still others for potable water.

FIG. 4 depicts the conduits and pipes running through the complex, so as to provide the electricity and to bring water and take away wastewater for treatment in the system. It is preferable to design the complex with the appropriate easements 141 for pipes, conduits, ducts and cables running between and along floors of the complex.

### SOFC with SMR, Preheating and Post-Combustion

A solid oxide fuel cell (SOFC) is a device that electrically captures the chemical energy that is released when oxidizing a fuel, typically hydrogen. This provides a much cleaner and efficient process than obtained with normal combustion.

The SOFC consists of two sides, an anode, and a cathode, separated by a solid electrolyte.

At the anode, the hydrogen is oxidized according to the reaction

H₂+O₂->H₂O+2 e⁻,

producing two electrons per H₂ molecule. The electrons flow through the anode and exit the fuel cell where, due to the thermodynamic potential driving the reaction, the electrons can perform electrical work.

The electrons return to the fuel cell via the cathode where O₂ from the air is reduced according to the reaction:

O₂+4 e⁻2O²⁻

which produces two O²⁻ ions. These ions pass through the solid electrolyte commonly made of yttria stabilized zirconia (YSZ), which is electrically insulating, but at high temperatures, is conductive to the O²⁻ ions, and enters the anode side of the cell. Due to the temperature dependence of the electrolyte's ionic conductivity, the SOFC is run a very high temperatures to minimize resistive losses, usually 700-1,000° C.

For efficiency, the SOFC is typically run with a fuel utilization, U_{f} as close to 1 as possible, where

$$\frac{Uf = 1 - {MH}_{2 out}}{{MH}_{2 in}}$$

In practice, the upper limit for U_{f} is between 0.85 and 0.9. When run higher, the anode itself begins to be oxidized, damaging the fuel cell.

Due to this limit on U_{f}, there always remains some unreacted H₂. To capture the energy from this fuel, the anode and cathode exhaust streams are typically mixed and run through a combustor to oxidize the remaining fuel and extract the thermal energy. The combined, post-combustor, exhaust stream is used to power the SMR reaction, see below, and to preheat the incoming air and fuel. In the integrated system, the heat is also utilized to provide additional building utility needs as explained above and below.

The SOFC is designed to run with hydrogen as the fuel. While there are efforts to improve the availability and cost effectiveness of hydrogen as a fuel, it is presently more cost effective to use methane as the feedstock for the SOFC. Hydrogen can be readily produced from the methane using steam methane reforming (SMR) together with the water-gas shift reaction (WGS) to produce hydrogen and carbon dioxide.

### Heat Exchange Systems for Capturing and Transferring Heat from the SOFC Exhaust

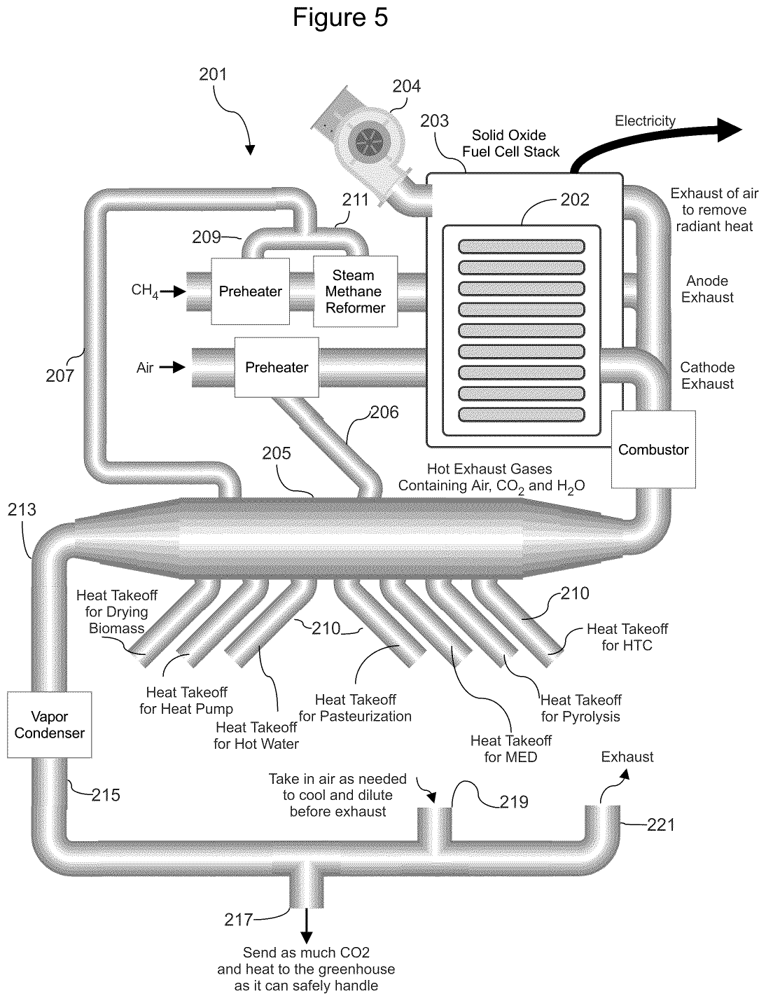

While FIG. 1 shows a simplified system where the various units are lined up to take heat off a SOFC exhaust gas stream in series, it is preferred that the system be designed with one or more heat exchange manifolds. Such a heat exchanger system 201 is shown in the schematic drawing of FIG. 5. As depicted, methane enters the system through the inlet 204. This methane may be supplied through a natural gas pipeline or may be provided from a tank, such as a tank of liquified natural gas (LNG). It is preferred to preheat the methane. This is accomplished in a preheater that receives hot air from the SOFC exhaust from conduits 207 and 209. After pre-heating, the methane is passed through a steam reformer, which also utilizes heat from the SOFC exhaust through conduits 207 and 211.

The steam methane reformer (SMR) is a device that converts natural gas (methane) into hydrogen gas, which serves as the fuel for the SOFC. In the SMR process, methane is mixed with steam (H₂O) and exposed to a catalyst at high temperatures, typically above 700° C. The catalyst facilitates a series of chemical reactions, including the steam reforming of methane and the water-gas shift reaction, which produce hydrogen gas (H₂) and carbon dioxide (CO₂) as byproducts. The generated hydrogen is then fed into the solid oxide fuel cell, where it electrochemically reacts with oxygen from the air to produce electricity, with water vapor and heat as the main byproducts. Because CO₂ is produced, an objective of the integrated system is to make use of as much of the CO₂ as possible (see the greenhouse discussion above and below) and take other measures to sequester carbon from other sources, so as to be carbon neutral or, more preferably, carbon negative.

Air is also introduced into a preheater, which is also preheated by hot exhaust from the SOFC through conduit 206.

The solid oxide fuel cell stack includes a housing 202, which is, in turn, housed in case 203. Preferably, the case is well insulated. In the depicted embodiment, the system includes a fan or blower 204 to blow air over and around the SOFC stack to remove radiant heat. This heated air then flows into the SOFC exhaust stream, so that all of the heat is captured in the system.

Alternatively, there is no blower and separate case 203. Instead, the amount of air introduced into the SOFC itself is selected so as to carry sufficient heat away from the SOFC stack.

The SOFC stack produces electricity, preferably enough to provide the power needed for the residents of a multi-resident complex. As noted elsewhere, it is preferred to deploy two SOFC stack units, so that each can back up the other in case of unexpected outages or so that each can be shut down for maintenance without interrupting the power supply to the complex.

The exhaust from the anodes and cathodes in the SOFC stack, along with the radiant heat capturing exhaust are combined and run through a combustor, in order to combust any unused H₂, CO, or CH₄. Naturally, the combustor may add to the heat contained in the SOFC exhaust.

From the combustor, the SOFC exhaust enters the heat exchange chamber 205. Within the chamber 205 is a number of individual heat exchangers that serve the purpose of take off heat from the SOFC exhaust and delivering it to one of the utility units in the system. Preferably, these units include a solid waste pyrolysis unit, a hydrothermal carbonization unit, a multi-effect distillation unit, a pasteurization unit, a water heating unit, a unit for heating water for use in a heat pump driven room heating and cooling system or an absorptive cooling unit, and a biomass drying unit. The take offs 210 from the individual heat exchangers are shown as a single conduit. However, each consists of an outlet, through which the heated fluid travels to the unit; and an inlet through which the cooled fluid returns to the heat exchanger.

The SOFC exhaust leaves the chamber 205 through conduit 213. At this point, a significant amount of heat has been removed from the exhaust stream. Conduit 213 takes the exhaust stream through a vapor condenser, to remove water from the exhaust stream. This condensed water is preferably passed to a water treatment unit in the system, such as the multi-effect distillation unit.

The SOFC exhaust stream exits the vapor condenser through conduit 215. The outlet 217 is used to divert the exhaust stream to a greenhouse. In this way the greenhouse can receive both heat and CO₂ to enhance growing plants in the greenhouse. As described in more detail below, systems are in place to ensure that the greenhouse does not get too much CO₂ or heat.

The system preferably includes an air intake 219, so that air can be used to cool and dilute the SOFC exhaust before it is released to the environment at exhaust 221. Preferably, sensors are used to determine how much air should be taken in at 219.

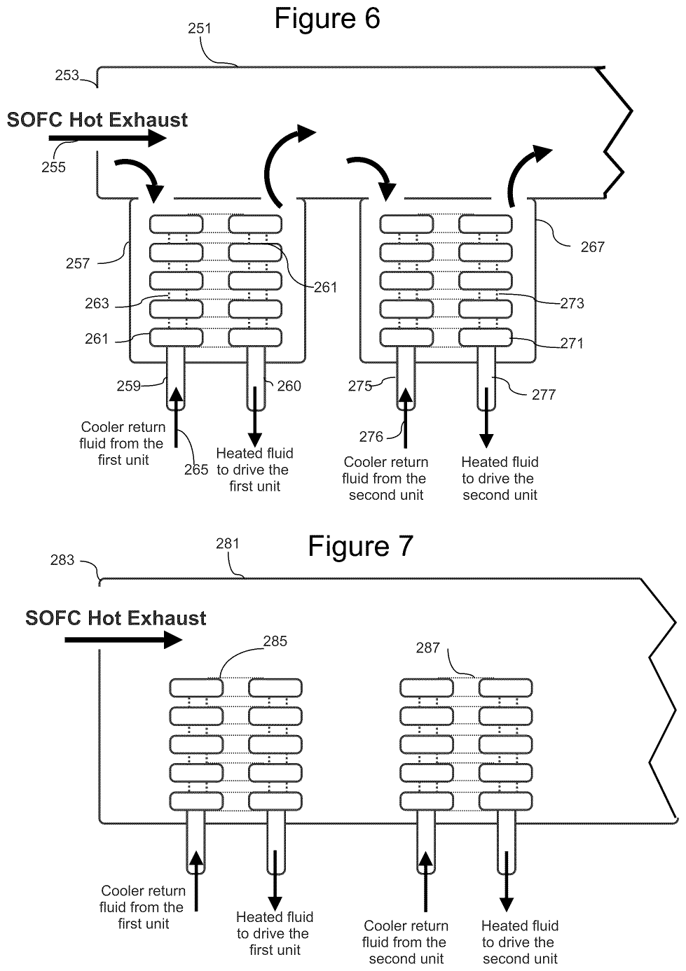

Now turning to FIG. 6, a cross-sectional view of part of a heat exchanger is depicted. The heat exchanger includes a SOFC exhaust chamber 251. SOFC hot exhaust is introduced into the chamber through inlet 253. A portion of that SOFC hot exhaust enters the first heat exchange chamber 257, whereupon the hot exhaust comes into contact with the first heat exchange component made up of a stack of hollow rings 261 connected by vertical conduits 263. Heat from the SOFC hot exhaust passes through the walls of the rings and vertical conduits and thus heats the heat transfer fluid 265 circulating therein. Cooled heat transfer fluid returning from the unit enters the heat exchange component through inlet 259 and exits through the outlet 260, after being heated in the heat exchanger, to flow to the unit through outlet 265.

A portion of the SOFC hot exhaust also enters the second heat exchanger chamber 267, whereupon the hot exhaust comes into contact the second heat exchange components, also made up of hollow rings 271, connected by vertical conduits 273, whereby the heat transfer fluid 276 is heated. Cooler heat transfer fluid returning from the second unit enters the second heat exchange component through inlet 275 and exits through outlet 277 to return to the second unit, after being heated in the heat exchanger.

FIG. 7 is a cross-sectional, partial view of another embodiment of a heat exchange manifold system, with the differences being that the heat exchange components 285 and 287 are located in the chamber 281 wherein the SOFC hot exhaust is introduced through inlet 283. In other words, there are not separate heat exchange chambers for each unit's heat exchanger.

The heat transfer fluid used in each heat exchange unit is selected based on the needs of that particular unit and the temperature of the SOFC exhaust at that point in the system. For some units, the fluid is air, i.e. an air to air heat exchanger. For others, the fluid is a liquid. The highest temperature liquids are molten salts, like eutectic mixtures of sodium nitrate and potassium nitrate. These mixtures can operate above 500° C. In other units, silicone-based heat transfer fluids can be used, as they can operate up to 400° C. Synthetic hydrocarbons are also available for temperatures up to 315° C. In general, the choice of heat transfer fluid should take into account factors such as temperature range, thermal stability, compatibility with materials, toxicity, environmental considerations, and cost.

It is noted that, in these FIGS. 5-7, only the most simple heat exchange manifolds are shown. It is considered to be within the skill in the art to tune the various components of the heat exchange manifold to achieve the desired results. For example, those units requiring more heat to drive them may use larger heat transfer components, while those requiring less heat may use smaller heat transfer components. The rate of flow of the heat transfer fluid can also be tuned to provide more or less heat to the unit. Because some units do not require a constant source of heat, the heat exchange system may use valves or other means to control when and how much heat is provided to the units. Preferably, this is all operated by a digital control system that operates the valves and other means for increasing, decreasing or stopping the supply of heat to each unit.

### Solid Waste Pyrolysis Unit

Pyrolysis of biomass to produce biochar is a thermochemical process that decomposes organic material, such as agricultural waste and residential waste, at elevated temperatures in the absence of oxygen. Biochar is essentially the carbon-rich solid product resulting from the pyrolysis process. This process has garnered interest due to its potential applications in soil amendment and carbon sequestration, among others.

Pyrolysis of biomass waste has important environmental and economic benefits. For one thing, the process has the effect of reducing waste. Biomass wastes, such as agricultural residues or forestry by-products, can be converted into value-added products. The process can also be used to mitigate climate change. By converting biomass to biochar and incorporating it into soil, carbon is effectively locked away, reducing the net carbon dioxide in the atmosphere. A typical disadvantage of pyrolysis of biomass waste is the energy cost in heating the biomass waste to the appropriate temperature. The present invention provide the distinct advantage of providing that heat in an integrated system with a fuel cell.

Pyrolysis typically occurs at temperatures ranging from 300° C. to 600° C. The duration for which the biomass remains in the pyrolysis reactor can vary, but slow pyrolysis (hours to days) is commonly used to maximize biochar yield. Oxygen is preferably excluded from the pyrolysis environment to prevent the biomass from burning.

The pyrolysis process yields three primary products, namely (1) biochar, which is a solid, carbon-rich product; (2) bio-oil (or Pyrolysis oil), which typically consists of a complex mixture of organic compounds in liquid form; and (3) syngas (or Pyrolysis gas), which is mixture of gases, predominantly carbon monoxide (CO), hydrogen (H2), and carbon dioxide (CO2). The relative yield of these products can be influenced by the operational conditions (temperature, residence time, heating rate) and the feedstock characteristics.

Biochar is a desirable product because of the following characteristics:
High Carbon Content: Typically greater than 70%, making it relatively stable and resistant to decomposition.
Porous Structure: This gives biochar a high surface area, which can be beneficial for adsorption applications.
Alkaline pH: Biochar can often have an alkaline pH, which might help in ameliorating acidic soils.
Cation Exchange Capacity (CEC): Some biochars have a high CEC, beneficial for soil fertility as it enhances the soil's ability to retain essential nutrients.
Biochar may be used in the following application:
Soil Amendment: When added to soil, biochar can enhance soil fertility, improve water retention, and increase microbial activity.
Carbon Sequestration: Given its stability, biochar can act as a carbon sink, sequestering carbon in soils for hundreds to thousands of years.
Pollutant Remediation: The porous structure of biochar makes it a potential candidate for adsorbing pollutants, such as heavy metals or organic contaminants.
Energy Source: Although its energy content is lower than the original biomass, biochar can still be used as a fuel in certain applications.

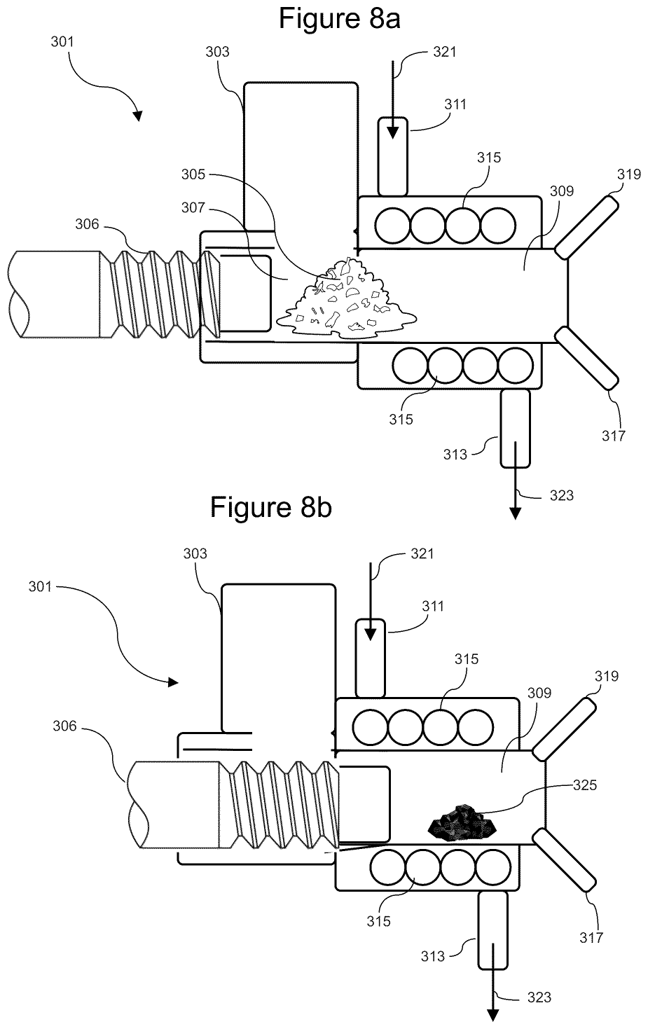

FIG. 8a is a schematic representation of a pyrolysis unit 301 for the present system. The biomass waste 305 is fed into the feed chamber 307 from the intake hopper 303. Depending on the source of the biomass waste, it may be preferable to include a shredder or other mechanism to improve the physical form of the biomass waste prior to pyrolysis. As discussed in detail below, it is preferred to dry the biomass waste before subjecting it to pyrolysis.

A mechanism, such as the drive screw 306 shown, an auger, or other type of conveyor, moves the biomass waste 305 into the pyrolysis chamber 309. Heat is supplied to the pyrolysis chamber by a fluid 321 that has been heated by the heat exchanger in contact with the SOFC exhaust (see discussion above) and enters through inlet 311. That heated fluid circulates through a coil 315 that surrounds the pyrolysis chamber, whereupon the slightly cooler fluid 323 exits through the outlet 313 and returns to the heat exchanger. Fans or blowers may be used to circulate the heat around and through the biomass waste. Importantly, the heating takes place in a reduced O₂ or no O₂ environment. This may be achieved by displacing air with an inert gas, such as nitrogen and/or by pulling a vacuum on the chamber.

In this depicted, simplified embodiment, the pyrolysis unit is set up to run as a batch process. In more sophisticated units, the pyrolysis chamber may take the form of a tunnel, so as to run a continuous process. The pyrolysis chamber may also take the form of a rotary kiln. Maintaining precise temperature control is crucial in pyrolysis. The reactor is heated to temperatures typically ranging from 300° C. to 800° C., depending on the feedstock and desired products.

As depicted in FIG. 8b, after a sufficient time in the pyrolysis chamber 309 at temperature, the biomass is converted to quantity of biochar 325, which can be expelled by further extension of the screw 306, or any other mechanism. At this point, the biochar may be put into containers or pelletized for ease of transport and later use.

An outlet 319 is provided for the gases generated during pyrolysis. Depending on the content of the gases, it may be preferably to use a gas scrubber or other technology to remove harmful components. Any water vapor in the gas stream may be condensed and fed into the water distillation unit described below.

An outlet 317 is provided for any liquids, such as bio-oil, produced by pyrolysis. Since the system does not have a ready use for bio-oil, the temperatures and dwell times are preferably selected so as to reduce the amount of bio-oil produced.

Inside the reactor, the waste material is subjected to high temperatures in the absence of oxygen. This is achieved through the use of heating elements, hot gases, or other heat sources.

### Hydrothermal Carbonization Unit

Hydrothermal carbonization (HTC) is a thermochemical process that converts organic materials, such as biomass or organic waste, into a carbon-rich substance called biochar through a combination of heat, pressure, and water. This process mimics the natural geological transformation that occurs over millions of years, where organic materials are converted into fossil fuels like coal.

The first step in HTC is to obtain and prepare the organic feedstock. The feedstock can include a wide range of materials, such as agricultural residues, sewage sludge, wood chips, algae, and food waste. The feedstock may be dried to reduce its moisture content. Nevertheless, for efficiency in the present system, the feedstock is maintained in water. Most preferably, the feedstock is blackwater from the complex. The feedstock is preferably treated with a mixer or macerator to create a fairly uniform slurry. The slurry is then loaded into a high-pressure reactor, which is sealed to prevent the escape of gases. The reactor is typically made of stainless steel or other corrosion-resistant materials to withstand the high pressures and temperatures used in HTC. The reactor is heated to temperatures typically ranging from 350 to 450 degrees Celsius, depending on the specific feedstock and desired outcome. The high temperature and pressure conditions within the reactor are crucial for the transformation of organic matter.

The pressure within the reactor is typically elevated to between 2000 and 5000 psi. This pressure helps facilitate the carbonization process. Under these high-temperature, high-pressure conditions, the organic matter in the feedstock undergoes complex chemical reactions. Carbon bonds are rearranged, and the carbon-rich compounds are stabilized. This process results in the formation of solid biochar, which is rich in carbon and has properties similar to coal.

After the desired reaction time, preferably between 5 seconds and 10 minutes, the reactor is cooled, and the pressure is reduced to safe levels. This allows the biochar to solidify and be separated from the liquid phase. Preferably, opening a valve that releases pressure and allows steam to vacate the chamber has the effect of cooling the chamber and its contents.

The biochar is preferably separated from the water by opening the valve so that the steam exits the chamber. Alternatively, in more conventional systems, the biochar is separated from the liquid by filtration or centrifugation. The remaining liquid, known as HTC wastewater, may contain soluble organic compounds and can be treated or further processed for energy recovery or nutrient recycling. Preferably, in the present system, this water is fed to the distillation unit described below.

The biochar is usually dried to reduce its moisture content further. Depending on the intended application, it can be further processed or activated to improve its properties. Biochar can be used as a solid fuel, soil amendment, or as a raw material for various applications, such as carbon sequestration, water purification, or energy production. As one goal of the present system is to be carbon neutral, or even carbon negative, the most preferred uses are those, like soil amendment, that keep the carbon sequestered.

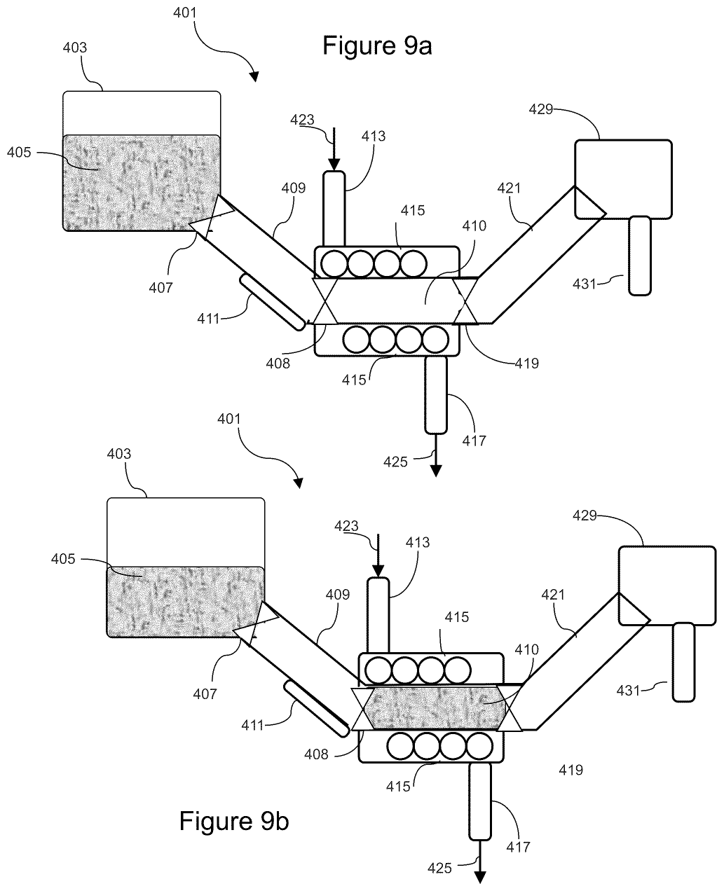

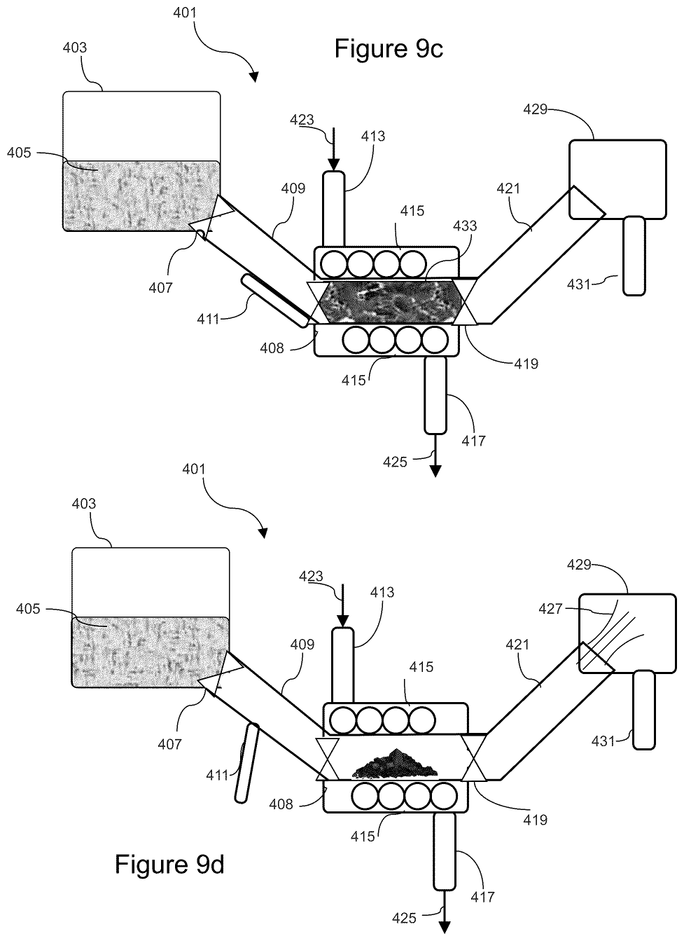

FIG. 9a shows a schematic of a hydrothermal carbonization unit 401. The unit includes a feed tank 403 holding blackwater 405. As mentioned, this is preferably blackwater from the multi-residence complex. The system valves 407, 408 and 419 that are actuated a different points in the process. A feed conduit 409 passes blackwater into the heating and pressure, reaction chamber 410. Heat is preferably supplied to this chamber by a fluid that is heated in a heat exchanger with the SOFC exhaust. The fluid 423 passes through inlet 413 into a coil 415 that encircles the reaction chamber 410. The slightly cooled fluid 425 exits through outlet 417 and returns to the heat exchanger to gain more heat. Venting conduit 421 is provided to vent steam from the reaction chamber 410 at the appropriate point in the cycle. That steam is condensed in the condenser 329 and exits through outlet 431.

As seen in FIG. 9b, to begin the batch process, valves 407 and 408 are opened and a quantity of black water is let into the reaction chamber. At this point, the reaction chamber is heated by the fluid 423 heated by the SOFC exhaust. Preferably, this is controlled by one or more valves that start and stop flow of the heat fluid into the coil 415.

As depicted in FIG. 9c, after an appropriate time at temperature and pressure, the organic compounds in the blackwater are carbonized to produce a new slurry 433. At this point, the supply of heated fluid 423 is cut off, for example by one or more valves, so that the reaction chamber can cool.

As depicted in FIG. 9d, the valve 419 is opened, which releases the pressure and allows the steam to escape from the reaction chamber, thus leaving a cooled mass of biochar in the reaction chamber. At this point, the access door 411 is opened and the biochar is removed from the reaction chamber by drawing a vacuum or by a mechanical means, such as a brush, auger, or some other type of conveyor.

The water vapor 427 that is vented from the reaction chamber is collected and condensed in the condenser 429. At this point, depending on the process for condensing the water, it may include some dissolved organic or inorganic materials. As such, this water produced by the HTC unit may best be fed to the distillation unit discussed below. Alternatively, it may be suitable to be returned for flush water in the toilets in the complex.

The temperature, pressure and dwell time are all selected to optimize performance and efficiency. Preferably, the temperature is between 250 and 900° C., more preferably between 350 and 500° C. and most preferably between 375 and 450° C. The pressure is supplied by heating the blackwater slurry with the valves 408 and 419 closed. Preferably, the pressure increases to between 2000 and 6000 psi, more preferably between 3000 and 5000 psi, and most preferably between 3300 and 4500 psi. The dwell time for the slurry at this elevated time and pressure is preferably between 5 second and 30 minutes, more preferably between 20 seconds and 10 minutes, and most preferably between 30 and 60 seconds.

The preferred dimensions of the HTC unit depend on the expected volume of blackwater to be treated. The unit can be sized for an individual residence, or preferably sized to handle all of the blackwater from the complex. For example, if the complex houses 200 people, and each of those people generates around 3.5 gallons of blackwater per day, the system should be designed to handle about 1000 gallons per day, to provide a comfortable buffer.

Within the reaction chamber, the temperature and pressure are typically raised to bring water to a supercritical phase. The critical temperature of water is 374.15° C. at a critical pressure of 22.06 megapascals (approximately 3,200 psi). At this critical point, water exists as a distinct phase known as a supercritical fluid, which exhibits properties that are intermediate between those of a gas and a liquid. In the supercritical phase, water lacks a distinct liquid-gas boundary, and it can diffuse through solids like a gas while dissolving materials like a liquid. Supercritical water's high solvency and temperature assist in making the chemical changes in the organic matter to change the organic matter into biochar. The heat carrying capacity of water, often referred to as its heat capacity or specific heat capacity, is relatively high compared to many other substances. The specific heat capacity of water is approximately 4.184 joules per gram-degree Celsius (J/g° C.) or 1 calorie per gram-degree Celsius (cal/g° C.). This means that it takes 4.184 joules of energy to raise the temperature of 1 gram of water by 1 degree Celsius.

Water in its super critical phase is highly corrosive, so specialized materials are often needed in making devices that deal with water at super critical temperatures. Stainless steel is used for this purpose in the reaction chamber. In other areas of the device other materials are also used. Valves for high-temperature applications need to be constructed from materials that can withstand extreme heat without degradation. Here are some common types of high-temperature valves and the materials often used for them Ball valves are versatile and commonly used in high-temperature applications. For extreme temperatures, they are often made from materials like stainless steel (e.g., 316 or 310), Inconel, or Hastelloy. These materials offer excellent resistance to corrosion and high-temperature stability. Gate valves are suitable for applications where a tight shutoff is required at high temperatures. Gate valves for high-temperature service are typically constructed from materials such as carbon steel, stainless steel, or alloy steel. Globe valves are used in applications requiring fine control and throttling at high temperatures. They are typically made from materials like stainless steel, Inconel, or Hastelloy.

Butterfly valves are commonly used in industrial processes and can be suitable for high-temperature applications. Materials like stainless steel, Inconel, or Hastelloy are used for high-temperature butterfly valves. Check valves prevent reverse flow and are used in various high-temperature applications. They are made from materials like stainless steel, Inconel, or Hastelloy. Plug valves are often used for high-temperature applications due to their simple design and reliable sealing. They can be made from stainless steel, Inconel, or other high-temperature alloys. Diaphragm valves are used in applications that require precise flow control at high temperatures. They are constructed from materials like stainless steel or other high-temperature alloys. In high-temperature steam systems, specialized steam traps made from materials like stainless steel or alloy steel are used to remove condensate and prevent steam loss. Inconel is a family of high-performance, nickel-chromium-based superalloys known for their exceptional resistance to high temperatures, corrosion, and mechanical stress. These alloys are used in a wide range of applications, particularly in industries where extreme conditions are encountered, such as aerospace, chemical processing, nuclear power, and gas turbines. Key characteristics of Inconel alloys include Inconel alloys can withstand extremely high temperatures, making them suitable for applications where materials must maintain their integrity at elevated temperatures. Some Inconel alloys can operate at temperatures exceeding 2,000° C. (3,632° F.). Inconel alloys exhibit excellent resistance to corrosion in harsh environments, including exposure to acids, alkalis, and various corrosive gases. This corrosion resistance is due to the presence of nickel and chromium in the alloy. Inconel alloys maintain their mechanical strength and integrity even under high-stress conditions. They are known for their fatigue resistance and ability to withstand mechanical wear and tear. Inconel alloys have a high resistance to oxidation, which means they do not readily react with oxygen at high temperatures. This property helps maintain their structural stability in oxidizing atmospheres. Inconel alloys exhibit resistance to creep deformation, which is the gradual deformation of materials under constant load at high temperatures. Inconel alloys are chemically stable, making them suitable for use in various chemical processing applications.

### Multi-Effect Distillation (Desalination)

Multi-Effect Distillation (MED) is a process used for producing fresh water from saline sources, such as seawater and sewer water. It is one of several water purification techniques and is especially popular due to its relatively high thermal efficiency. The fundamental idea behind MED is to use the vapor produced in one effect (or stage) as the heating medium for the subsequent effect. This process is repeated across multiple effects or stages, which allows for efficient use of thermal energy.

Multi-effect distillation (MED) is preferably used in the current system for the treatment of gray water, domestic waste water without fecal contamination, i.e. gray water. Distillation is a process that fully boils water, and then condenses it in separate location, leaving behind any contaminants and killing any bacteria present. MED consists of multiple distillers or effects which are in parallel, but are thermally in series. The first effect uses heat from the exhaust gas to boil the water via a gas-liquid heat exchanger. As the steam from the first effect condenses, the latent heat given off is used to boil the water in the next effect. This process is repeated for the next effect. The heat from each effect is used to boil the water in the next, with each effect boiling at a lower temperature and pressure than the previous. The thermal energy transferred into the first effect from the exhaust gas is recycled in each of the subsequent effects. The MED provides an increase in efficiency compared to direct distillation by boiling a larger mass of water with a given amount of energy than would be predicted considering the specific latent heat of the mass of water boiled.

As noted, in the first effect, waste water is heated by heat from the SOFC exhaust. This is accomplished by an appropriately sized heat exchanger. Heating the water water causes the water to evaporate. The produced vapor is then used to heat the feed in the second effect. As the vapor condenses in the second effect, it releases its latent heat, causing water in the second effect to evaporate. This process continues, with vapor from each effect being used to heat the next, until the last effect. In each effect, a portion of the waste water evaporates and is then condensed on the cooler side to produce fresh water.

Each effect operates at a slightly lower pressure (and thus a lower boiling point) than the previous one. This maintains a temperature difference between the effects, driving the evaporation and condensation processes.

In the present system, the MED unit is preferably used to treat water that has salts and other impurities to keep it from being drinkable, or to keep it from being used for things such as cleaning and watering gardens and landscaping. Alternatively, if needed, the MED unit can be used for desalination of sea water, or other brackish water.

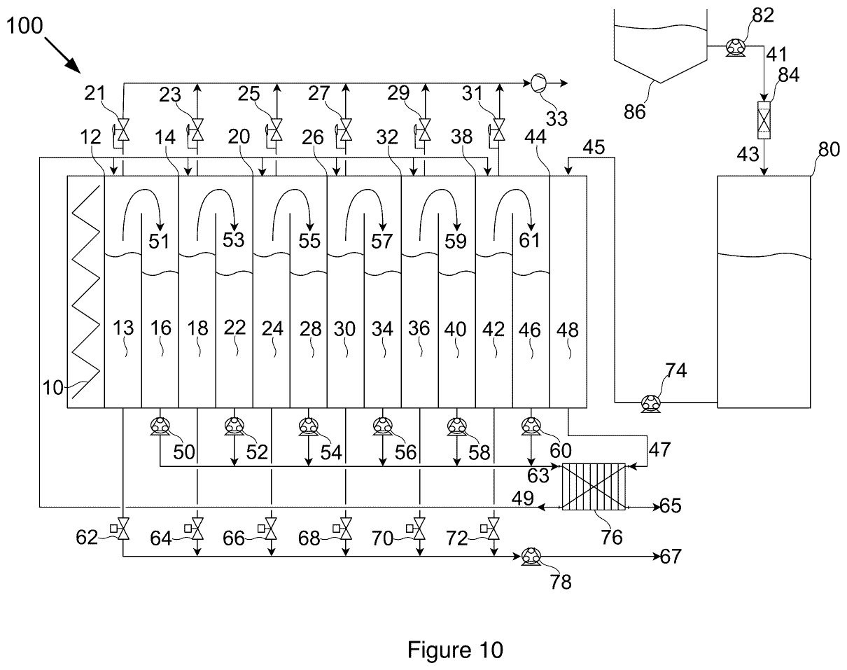

A suitable MED system is described in U.S. Pat. No. 11,920,048, entitled Method and System for Batch Multi-Effect Distillation, the entire disclosure of which is incorporated by reference. FIG. 10 is a schematic diagram showing a method for conducting batch multi-effect distillation at 100 that may be used in one embodiment of the present invention. A gray water tank 86, a gray water pump 82, a solids filter 84, a feed tank 80, and a feed pump 74 are provided. A first, second, third, fourth, fifth, sixth, and seventh heat exchanger 12, 14, 20, 26, 32, 38, and 44, respectively, are provided. The first heat exchanger 12 has an electrical heating element 10 to heat brine warming chamber 13. The second through sixth heat exchangers 14, 20, 26, 32, and 38 each have steam condensing chambers 16, 22, 28, 34, 40, and 46, respectively, and brine warming chambers 18, 24, 30, 36, 42, and 48, respectively. The brine chambers 13, 18, 24, 30, 36, and 42 each have a connection to a pressure regulator 21, 23, 25, 27, 29, and 31, respectively, each connected to a vacuum pump 33. Each of the steam condensing chambers 16, 22, 28, 34, 40, and 46 have a peristaltic pump, 50, 52, 54, 56, 58, and 60, respectively, to remove condensate. An eighth heat exchanger 76 is used to preheat the feed stream 47.

A gray water stream 41, comprising water, solutes, particulates, is pumped from the gray water tank 86 by the gray water pump 82 through the solids filter 84, removing particulates over a chosen size from the gray water 41, resulting in a feed stream 43 that is passed into the feed tank 80. The chosen size depends on the size of particulates that the valves 62, 64, 66, 68, 70, and 72, the pumps 74 and 78, and piping through the heat exchangers 12, 14, 20, 26, 32, 38, 44, and 76 can accommodate. In a preferred embodiment, all particles over ⅛″ in diameter are removed. In a more preferred embodiment, all particles over 100 microns are removed. The feed stream 43 is pumped by feed pump 74 through brine warming chamber 48 as feed stream 45, and through heat exchanger 76, resulting in a warmed feed stream 49, which fills the brine warming chambers 13, 18, 24, 30, 36, and 42. Once all the brine warming chambers are full the feed pump 74 shuts off, isolating the feed tank 80 from the brine warming chambers. The brine warming chamber 13 is heated by the heater 10, producing steam stream 51, leaving a brine concentrate behind. Steam stream 51 passes into the steam condensing chamber 16 and is condensed, resulting in a condensate. Condensation heats brine warming chamber 18, producing steam stream 53, leaving a brine concentrate behind. Steam stream 53 passes into the steam condensing chamber 22 and is condensed, resulting in a condensate. Condensation heats brine warming chamber 24, producing steam stream 55, leaving a brine concentrate behind. Steam stream 55 passes into the steam condensing chamber 28 and is condensed, resulting in a condensate. Condensation heats brine warming chamber 30, producing steam stream 57, leaving a brine concentrate behind. Steam stream 57 passes into the steam condensing chamber 34 and is condensed, resulting in a condensate. Condensation heats brine warming chamber 36, producing steam stream 59, leaving a brine concentrate behind. Steam stream 59 passes into the steam condensing chamber 40 and is condensed, resulting in a condensate. Condensation heats brine warming chamber 42, producing steam stream 61, leaving a brine concentrate behind. Steam stream 61 passes into the steam condensing chamber 46 and is condensed, resulting in a condensate. Condensation heats brine warming chamber 48, warming the feed stream 45. The vacuum pump 33 and pressure regulators 21, 23, 25, 27, 29, and 31 reduce pressure in each of the brine warming chambers 13, 18, 24, 30, 36, and 42 to a pressure that allows the heater 10 or condensation of steam in the steam condensing chambers 16, 22, 28, 34, and 40, respectively, to boil the brine in the brine warming chambers 13, 18, 24, 30, 36, and 42.

In a preferred embodiment, the filter 80 is cleaned by backflush, sending the filtered material to the blackwater system.

In a preferred embodiment, concentrated brine 67 is removed from the brine warming chambers 13, 18, 24, 30, 36, and 42 after a batch is completed through valves 62, 64, 66, 68, 70, and 72, respectively, by pump 78 and is passed into a blackwater treatment system. The water remaining in the brine concentrate assists in transport of the blackwater. In an alternate embodiment, the brine concentrate is dumped into a typical waste disposal system.

In this embodiment, as a batch completes the condensate is removed as stream 63 and used to preheat the feed stream 47 of the next batch, resulting in a cooled condensate stream 65. In other embodiments, the preheating step is excluded.

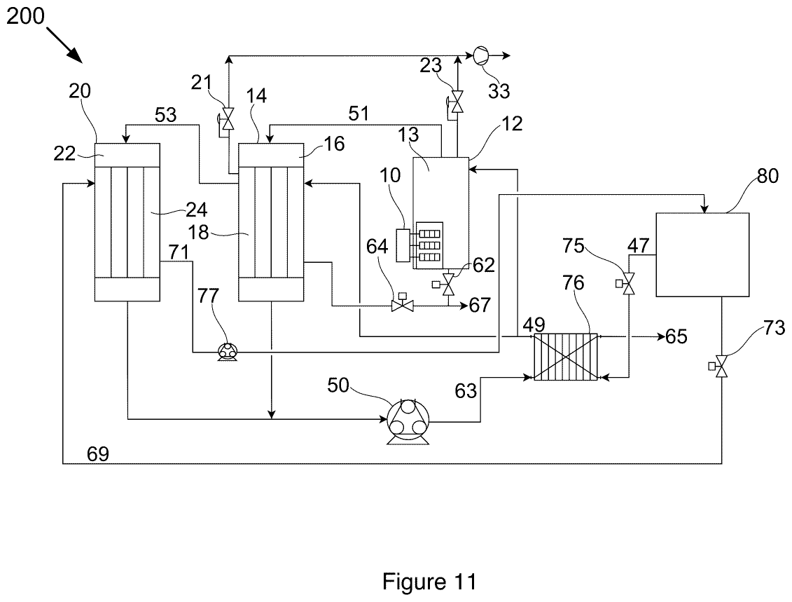

FIG. 11 is a block flow diagram showing a method for conducting batch multi-effect distillation at 200 that may be used in one embodiment of the present invention. A multi-effect distillation system and peripherals are provided. This includes an electric heater 10, a first, a second, and a third heat exchanger 12, 14, and 20 in series, a feed tank 80, a preheating exchanger 76, isolation valves 73 and 75, discharge valves 62 and 64, discharge pump 77, condensate pump 50, vacuum pump 33, and pressure regulators 21 and 23. A feed stream 69 is passed from the feed tank 80 through the isolation valve 73 into the brine side 24 of the third heat exchanger 20. A feed stream 47 is passed from the feed tank 80 through the isolation valve 75 and is warmed across the preheating exchanger 76 to produce warmed feed stream 49, which is passed into the brine sides 13 and 18 of the first and second heat exchangers 12 and 14. The brine sides 13, 18, and 24 are isolated from the feed source by closing the isolation valves 73 and 75. The vacuum pump 33 and the pressure regulators 21 and 23 reduce the pressure in the brine side 13 and the brine side 18 of the first and second heat exchangers 12 and 14 to pressures P1 and P2, respectively. The pressures P1 and P2 are chosen such that heat provided by the heater or the steam stream 51, respectively, is sufficient to boil the feed streams. The electric heater 10 heats the brine side 13 of the first heat exchanger 12, producing a steam stream 51 and leaving behind a brine concentrate. The steam stream 51 passes into the steam side 16 of the second heat exchanger 14 where it condenses, resulting in a condensate. Condensation heats the brine side 18 of the second heat exchanger, producing steam stream 53, leaving a brine concentrate behind. The steam stream 53 passes into the steam side 24 of the third heat exchanger 20 where it condenses, resulting in a condensate. Condensation heats the brine side 24 of the third heat exchanger 20, resulting in a warmed feed stream 71 that is passed through discharge pump 77 into the feed tank 80 after the batch is completed. The brine concentrate from the first and second heat exchangers 12 and 14 is passed through discharge valves 62 and 64 and out of the system as a brine discharge 67. The condensate 63 from the second and third heat exchangers 14 and 20 is pumped by pump 50 through the preheating exchanger 76, warming the feed stream 47 of the next batch.

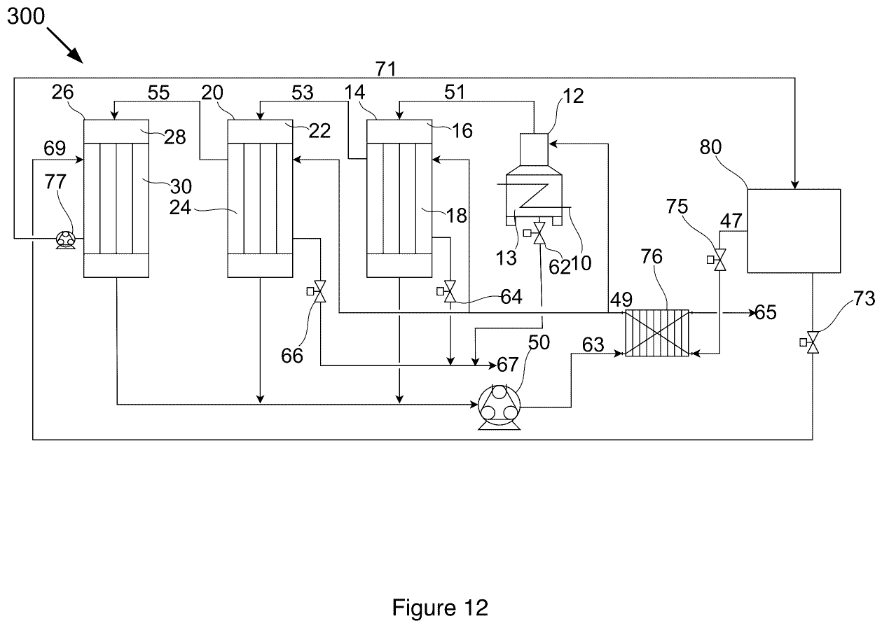

FIG. 12 is a schematic diagram showing a method for conducting batch multi-effect distillation at 300 that may be used in one embodiment of the present invention. A multi-effect distillation system and peripherals are provided. This includes a burner 10, a first, a second, a third, and a fourth heat exchanger 12, 14, 20, and 26 in series, a feed tank 80, a preheating exchanger 76, isolation valves 73 and 75, discharge valves 62, 64, and 66, discharge pump 77, and condensate pump 50. Vacuum pumps and pressure regulators are not shown for clarity of drawing but would be included. A feed stream 69 is passed from the feed tank 80 through the isolation valve 73 into the brine side 30 of the fourth heat exchanger 20. A feed stream 47 is passed from the feed tank 80 through the isolation valve 75 and is warmed across the preheating exchanger 76 to produce warmed feed stream 49, which is passed into the brine sides 13, 18, and 24 of the first and second heat exchangers 12 and 14. The brine sides 13, 18, 24, and 30 are isolated from the feed source by closing the isolation valves 73 and 75. The vacuum pump and the pressure regulators reduce the pressure in the brine sides 13, 18, and 24 of the first, second, and third heat exchangers 12, 14, and 20 to pressures P1, P2, and P3, respectively. The pressures P1, P2, and P3 are chosen such that heat provided by the heater or the steam streams 51 and 53, respectively, is sufficient to boil the feed streams. The burner 10 heats the brine side 13 of the first heat exchanger 12, producing a steam stream 51 and leaving behind a brine concentrate. The steam stream 51 passes into the steam side 16 of the second heat exchanger 14 where it condenses, resulting in a condensate. Condensation heats the brine side 18 of the second heat exchanger, producing steam stream 53, leaving a brine concentrate behind. The steam stream 53 passes into the steam side 24 of the third heat exchanger 20 where it condenses, resulting in a condensate. Condensation heats the brine side 24 of the third heat exchanger 20, resulting in a warmed feed stream 71 that is passed through discharge pump 77 into the feed tank 80 after the batch is completed. The brine concentrate from the first and second heat exchangers 12 and 14 is passed through discharge valves 62 and 64 and out of the system as a brine discharge 67. The condensate 63 from the second and third heat exchangers 14 and 20 is pumped by pump 50 through the preheating exchanger 76, warming the feed stream 47 of the next batch.

### Pasteurization

Pasteurization of water is a process that involves heating water to a specific temperature to kill or inactivate harmful microorganisms, such as bacteria, viruses, and parasites, thereby making the water safe for consumption. Typically, water is heated to around 70° C. (158° F.) for a brief period, usually less than a minute, and then rapidly cooled to ensure it remains potable without affecting its taste or chemical composition. Pasteurization is an effective method for treating drinking water, especially in situations where access to clean and safe water sources is limited. It provides a reliable means of reducing the risk of waterborne diseases.

Because the water system may be a closed loop, large water storage tanks are required. To keep the stored water clean and free of bacteria without the use of chemicals, a continuous pasteurization process is preferably used. Pasteurization is the process of heating a liquid briefly to a high temperature without boiling to kill any bacteria and cooling it down again. For this application, see FIG. 5, a target temperature of 80 C is used. The water is heated directly by the exhaust gas using a liquid-gas heat exchanger. The flowrate of either the water, gas, or both can be varied to ensure the target temperature is reached, but not exceeded, to kill the bacteria. A secondary liquid-liquid heat exchanger is used to improve the thermal efficiency of the system. As the water to be treated enters from the storage tank, it is preheated by the treated water returning to the tank. The water returning to the tank transfers a large portion of its heat to the incoming water, minimizing the power supplied to the water by the exhaust gas. As a result, the efficiency of this heat exchanger has a large impact on the overall process efficiency.

A suitable pasteurization system is described in U.S. patent application Ser. No. 17/747,492, entitled System for Sanitizing Water in a Container. The entire disclosure of this application is incorporated herein by reference. Water in a container can provide a haven for many undesirable microorganisms, such as odor causing bacteria and even disease-causing pathogens. Some of the undesirable microorganisms that can grow in water include Legionella, Pseudomonas, Cholera and Cryptosporidium. These microorganisms can cause rashes and illness. They are introduced to the container in a variety of ways. Some are airborne and begin colonizing when the pathogen falls in the water, others are found in soil, and others are found on human skin.

Heat can be an effective method for destroying or deactivating undesirable microorganisms in liquids. Boiling water has been used for centuries to purify water and make it safe to drink. Pasteurization is another method of sanitizing using heat. Pasteurization typically involves heating liquids to below 212° F. (100° C.) and holding them at that temperature for a time sufficient to destroy or deactivate those undesirable microorganisms.

The pasteurizing unit uses heat to destroy or deactivate undesirable microorganisms, it is different from conventional pasteurization and its use in other liquids. In conventional pasteurization the liquid is heated, either all at once in a vessel, or as it all passes through a conduit. As such, pasteurization is a typically a one-time event. In the preferred sanitizing system described herein, small volumes of the liquid are sanitized and then returned to the volume of the container. Preferably, this is done as an ongoing process and is not a one-time event.

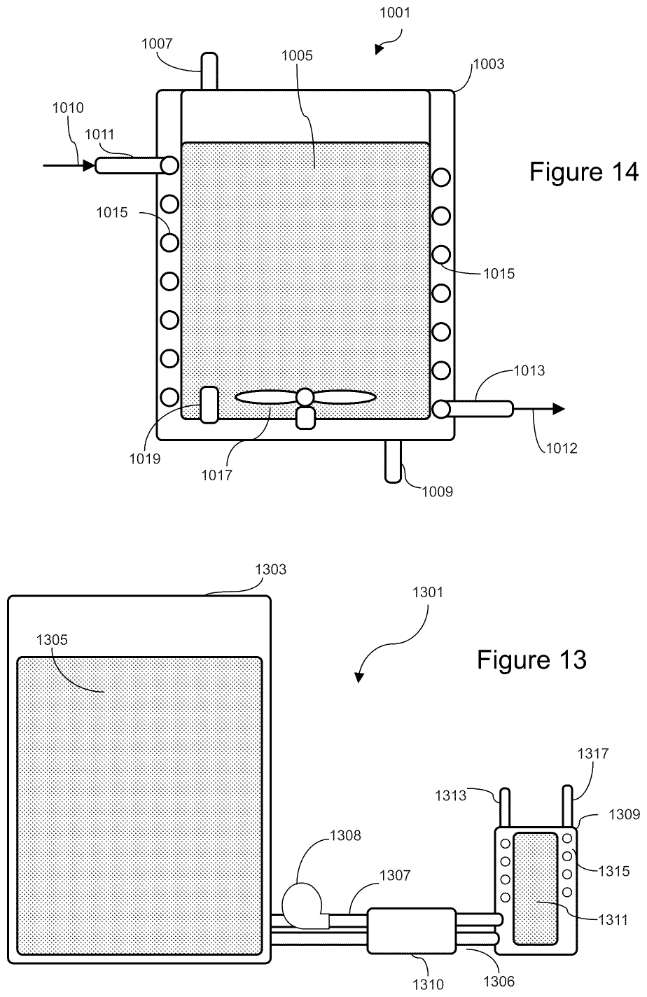

Now referring to FIG. 13, which shows a pasteurization system 1301. The system can be used with a variety of water sources. For example, the water source may be from a water storage tank, holding water for human or animal consumption. The water source may also be the water output from the MED unit described above. Depending on the local climate and season, the water source may also be rainwater.

The preferred system continually sanitizes small volumes of the water from the container until all or substantially all of the water has been cycled through the sanitizing system. Also, after conventional pasteurization, the liquid is sealed, so as to prevent re-contamination and often refrigerated. In contrast, the container to which the sanitizing system is attached remains accessible by microorganisms and recontamination. This can be for any of a variety of reasons. The container may be open where the surface of the water is exposed to the environment. Additionally, the container may continuously receive water collected from contaminated sources. As such, the continuous operation of the system is even more advantageous.

The pasteurization system includes a tank 1303, which holds an amount water 1305. Pump 1308 pumps water out of the tank through line 1307 into the heat exchanger 1310. This heat exchanger allows the water in the line 1307 going to the heat exchanger to capture a high percentage of the heat from the water in the line 1306 returning the pasteurized (heated) water to the tank 1303. The purpose of the heat exchanger is two-fold. First, by recovering much of the heat, the unit operates more efficiently, and can draw less heat from the overall system. Second, by taking heat from, i.e. cooling, the water returning to the tank, there is less chance that the water in the tank has a significant rise in temperature. A preferred heat exchanger is described below.

The pasteurizing chamber 1309 is enlarged for convenience. Preferably, it is much smaller than the main tank 1303. The water in the pasteurizing chamber 1311 is heated by a heat transfer fluid that enters the unit through inlet 1313 and circulates in coil 1315 around the chamber. By this the temperature of the water is raised to the preferred pasteurization temperature, preferably above 70° C. The heat transfer fluid, slightly cooled, exits the coil through outlet 1317.

The sanitizing chamber 1309 needs to be large enough to heat a sufficient volume of water to cycle through the volume of water in the container quickly enough to prevent growth of the undesirable microorganisms, while still being small enough to efficiently heat the full volume of water in the container. Stated another way, the small portion of water in the sanitizing chamber is preferably less than 20 percent of the water, more preferably less than 10 percent, even more preferably less than 5 percent and most preferably less than 1 percent.

### Hot Water Heater

The preferred system includes a central water heating system for the multi-residence complex, providing a dependable and efficient source of hot water to meet the needs of all the residents. This system centrally heats water, distributing it through a network of well-insulated pipes to each residence unit, ensuring consistent and reliable access to hot water for bathing, cleaning, and other daily tasks. Designed for efficiency, the central heating system not only reduces energy consumption but also lowers utility costs for the residents.

FIG. 14 is a schematic diagram of a central water heating unit 1001. The unit includes a tank 1003 that holds a sufficient quantity of water 1005. The water enters the tank through inlet 1007 and exits through outlet 1009. Conventional water pumps are used as needed to transport the water and provide pressure in the residential hot water lines. The tank is heated as a heat transfer fluid 1010 that has been heated by the SOFC exhaust enters through the inlet 1011 and circulates around the tank through a coil 1015. The heat transfer fluid 1012 with slightly less heat exits the coil through outlet 1013. In alternative embodiments, the SOFC exhaust gas itself if valved and made to pass through the coil with a controlled flow rate to achieve the desired temperature in the water.

The tank 1003 is outfitted with a stirrer 1017 that moves the water around in the tank to ensure consistent temperatures from top to bottom. The tank is also equipped with a thermostat 1019, which is used with a series of controllers and valves on the heat transfer fluid, to maintain the desired temperature of the water within the tank, typically between 50 and 60° C.

### HVAC

Preferably, one of the utilities provided by the system is heating and air conditioning (HVAC) for the complex. This can be accomplished through various means, preferably by a combination of units. It is preferable for each residence to have control over its own HVAC. Nevertheless, the HVAC for the common areas, such as hallways and lobbies, are preferably provided centrally.

It is noted that the HVAC system(s) preferably contribute air filtering and monitoring in the complex. The monitoring can be accomplished with conventional sensors located throughout the building to monitor the air temperature, and to monitor for levels of CO₂, CO, CH₄ and other harmful gasses, as well as monitoring for excess particulates, such as pollen and dust. The filtering can be accomplished by simply running forced air through conventional air filters. Alternatively, other filtering means, such as electrostatic filtering, can be used. Preferably, the system also draws in fresh air from outside the complex at preferred rates.

In its simplest form, heat from the SOFC exhaust can be used to warm air for the complex. Forced air heating, with blowers powered by the electricity from the SOFC, can be provided for the common areas and use heat from the SOFC to achieve to the desired temperature.

Alternatively, or additionally, heat from the SOFC exhaust can be used to heat water or some other fluid, such as glycol, that is run through the building and used for radiant heating, such as in floors, walls, ceilings or separate radiators.

The cooling component of the system can be provided by conventional refrigeration air conditioning using electricity from the SOFC, by reversible heat pumps or by absorptive cooling. Each of these systems is discussed below.

### Using Radiant Heat and Cooling

As noted, heat from the SOFC may be used to heat water or another fluid such as glycol. That heated fluid can be circulated in the complex, either throughout the complex or just in common areas, to provide radiant heat. Naturally, such systems include thermostats and control means for achieving the desired temperatures. Suitable systems to be used in the current system are describe in U.S. Pat. No. 11,131,464, entitled Hydronic Panel; U.S. Pat. No. 11,300,303, entitled Radiant Panel with Heat Exchange Device and U.S. Pat. No. 11,441,315, entitled System for Heating and Cooling a Room with Insulating Layer. The entire disclosure of these three patents is incorporated herein by this reference.

### HVAC with Heat Pumps

A heat pump is a device that uses work to transfer heat from a cool space to a warm space by transferring thermal energy using a refrigeration cycle, cooling the cool space and warming the warm space. In cold weather a heat pump can move heat from the cool outdoors to warm a house. The heat pump may also be designed to move heat from the house to the warmer outdoors in warm weather. As they transfer heat rather than generating heat, they are more energy-efficient than other ways of heating a home. While air source heat pumps are the most common, heat pumps are also designed to use a reservoir of water as the heat sink.

The heart of the system is the heat pump itself. It consists of a compressor, evaporator, condenser, and a refrigerant loop. The heat pump can reverse its operation to provide both heating and cooling. Preferably, each residence is provided with its own heat pump and individual controls. Each residence also needs an air distribution system, which include fans and the like for moving the heated or cooled air around the residence. In heating mode, warm air is distributed into the residence, while in cooling mode, cool air is circulated.

The system also requires a heat sink. This is provided in the present system preferably by providing a centralized large tank of water that is maintained at a constant temperature by a controlled heat transfer of from the SOFC exhaust. Alternatively, the heat sink reservoir is circulated in pipes through the complex, so as to bring the heat sink to the individual heat pump units. In either event, this water thus serves as a stable thermal reservoir, maintaining a relatively constant temperature throughout the year.

In some climates it is preferable to make seasonal changes in the temperature of the fluid in the heat sink. For example, in cooler months, it is preferable to use the heat from the SOFC exhaust to keep the heat sink warmer, so that the system does not have to expend as much work to heat the central areas and individual residences in the complex. In warmer months, it may be preferable to use heat from the SOFC exhaust to drive an absorptive cooling unit (see discussion below) to lower the temperature of the fluid in the heat sink. In this way, the heat pumps can work less hard in cooling the respective spaces.

In more preferred embodiments, the HVAC system uses predictive models and local weather information to make the necessary adjustments in the temperature of the heat sink as frequently as needed to increase efficiency of the system. Such adjustments to the heat sink temperature could be made daily.

In heating mode, the heat pump's refrigerant absorbs heat from the water in the heat sink reservoir. As the refrigerant evaporates, it becomes a low-pressure gas and releases heat into the heat exchanger coil within the air handler. The warm air generated in the heat exchanger is then distributed in the residence.

In cooling mode, the process is reversed. The heat pump extracts heat from the indoor air, which is at a higher temperature, and releases it into the water reservoir. As the refrigerant condenses, it releases heat, which is transferred to the water in the reservoir. The cooled air is distributed through the ductwork to cool the building.

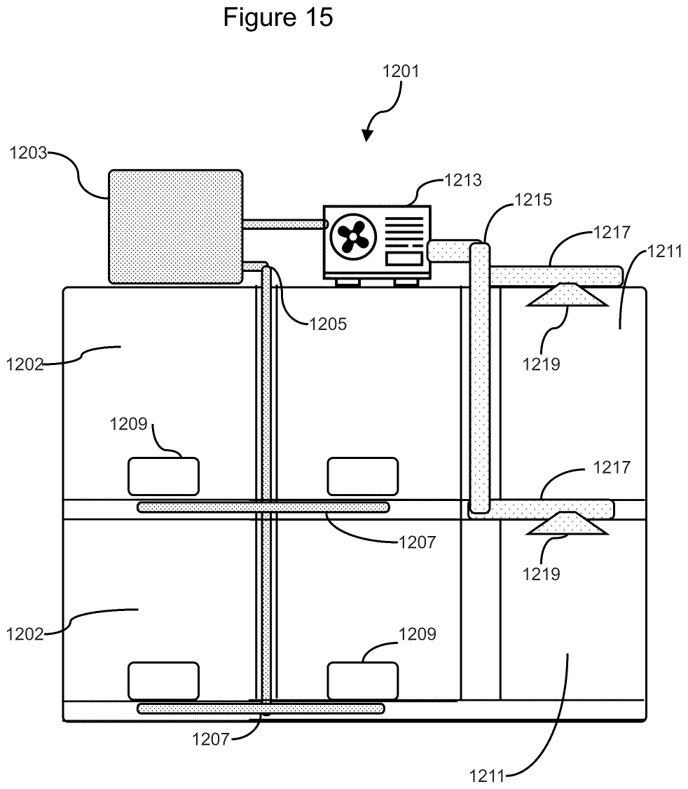

As depicted in FIG. 15, each residential unit 1202 is provided with its own heat pump system 1209, so that the residents of that unit can control the temperature and airflow for themselves. The system 1201 includes a central tank 1203 which maintains water or another heat transfer fluid at the desired temperature. The temperature controlled water acts as the heat sink for the individual heat pumps 1209. That water is distributed through the complex by vertical pipes 1205 and horizontal pipes 1207. As such, the water, or other fluid used as the heat sink, is distributed throughout the complex so as to be accessible by these individual units 1209.

Alternatively, each individual unit may run its own heat transfer circuit to a centralized heat sink. Still alternatively, the system may include heat sinks, such as one on each floor or subzone of the complex, while the individual units include a heat transfer circuit extending to the nearest heat sink.

FIG. 15 also shows a heat pump 1213 that is used to provide heated and cooled air for the hallways 1211 and other common spaces in the complex. The heat pump uses the centralized heat sink 1203 and blows heated or cooled air through the vertical ducts 1215 and lateral ducts 1217 to distribute the heated or cooled air through the hallways and other common spaces. Vents or registers 1219 are provided at appropriate locations for this purpose. Suitable returns and ductwork are also provided.

### HVAC with Absorptive Cooling

Absorptive cooling, also known as absorption chilling or absorption refrigeration, is a type of cooling technology that uses a heat source to produce cooling effects. Unlike conventional vapor compression refrigeration systems that rely on mechanical compression to circulate refrigerant gases, absorptive chilling operates on a different principle. Absorptive cooling systems operate on a thermodynamic cycle known as the absorption cycle, which typically involves four main components: a generator, an absorber, a pump, and an evaporator. Absorptive cooling systems use a pair of working fluids, typically a refrigerant and an absorbent. Common combinations include ammonia (NH3) as the refrigerant and water (H2O) as the absorbent, or lithium bromide (LiBr) as the absorbent and water as the refrigerant.

The absorption cycle begins with a heat source, which, in the present system, is derived from the SOFC exhaust. This heat source is used to drive the cycle. The generator is where the heat source is applied to the working fluid pair. Heat causes the refrigerant to vaporize from the liquid phase, and the vapor is then absorbed by the absorbent. This process is endothermic, meaning it absorbs heat. The absorbent solution containing the dissolved refrigerant vapor is then passed to the absorber. In the absorber, the refrigerant is released from the absorbent as it absorbs heat from a cooling medium (e.g., air or water). This process is exothermic, releasing heat. A pump is used to circulate the absorbent solution from the absorber to the generator, creating a continuous loop. The pump requires a relatively small amount of energy compared to the compressor in vapor compression refrigeration systems. In the evaporator, the low-pressure refrigerant vaporizes and absorbs heat from the surroundings, which causes cooling. This is the part of the system where the desired cooling effect is produced. Absorptive cooling systems may also include a condenser, especially if they are used for air conditioning applications. The condenser releases the heat absorbed during the evaporator phase to the external environment.

### Biomass Drying

In the preferred embodiment, some of the heat from the SOFC exhaust is used to dry or desiccate biomass waste. The biomass waste may be generated by residents of the multi-residence complex, such as garden and/or landscaping waste. The biomass waste may also be generated outside the complex, such as by local farmers, gardeners or landscapers.

The biomass drying unit is designed to remove moisture from biomass materials efficiently, and to thereby lower the water activity of the waste. As such, it can be stored for later processing without rotting. Also, the biomass may be desiccated to the point that it can be compressed and put to various uses. For example, bricks or blocks of desiccated biomass may be encapsulated in a polymer film and used as structural components, such as in retaining walls or pavers. Preferably, the polymer film is derived from recycled plastics.

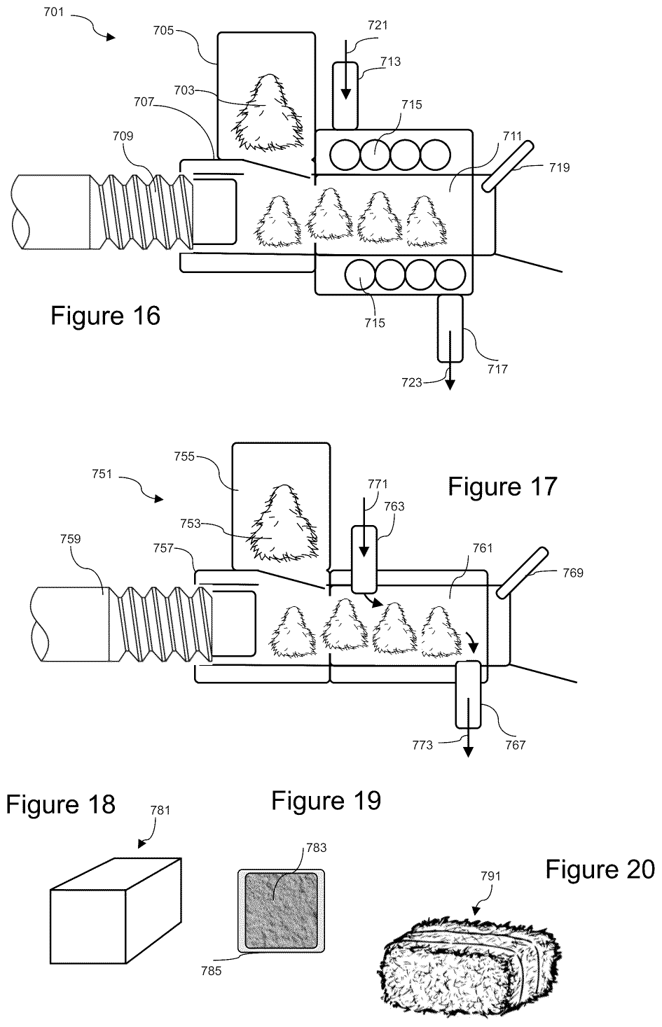

FIG. 16 schematically depicts one embodiment of a biomass dryer 701. In this embodiment, the biomass waste 703 is held in an infeed hopper 705. The biomass may include materials like wood chips, agricultural or landscaping wastes, residential waste or sewage sludge. In some embodiments, the biomass waste is pre-processed to achieve a desired size and quality.

In the simplified system show in FIG. 16, the biomass waste drops into the feed chamber 707, where it is pushed by auger or screw feeder 709 into the drying chamber 711. Other mechanical means, such as a conveyor or other type of pusher can be used instead. Also, the depicted mechanism is set up for a batch process. A continuous drying process, for example with a drying tunnel, is also contemplated.

In the embodiment depicted in FIG. 16, heat is provided for the drying chamber 711 by a heat transfer fluid 721 heated by the SOFC exhaust in the heat exchanger discussed above. This heated fluid enters the dryer through inlet 713 and circulates around the drying chamber in a coil 715 and exits through outlet 717, whereupon the less heated fluid 723 flows back to the heat exchanger. Preferably, a fan or blower is included to circulate air around and through the biomass as it is drying. The airflow and temperature within the chamber should be monitored and controlled for optimum drying conditions.

An outlet 717 for water vapor and other volatiles is provided. A slight vacuum may be used to draw the water vaper out of the chamber. Preferably, this water vapor is cooled and purified by multi-effect distillation, which is described above. Depending on the types and amounts of volatiles driven off by the drying process, it may be preferred to use a gas scrubber on the vapor stream.

A moisture sensor is preferably included as a means for knowing when the biomass in the chamber has been sufficiently dried. Preferably, the biomass is dried to less than 10% water, more preferably less than 5% water and most preferably below 1% water. The objective is to reduce the water activity in the biomass, to prevent rotting, decay, putrefaction, and fermentation.

Once dried, the biomass waste is pushed out of the drying chamber by further extension of the screw 709. Alternatively, a conveyor or other means can be used to move the dried biomass out of the drying chamber. Preferably, the dried biomass is compacted for convenience in further processing and transporting. Most preferably, the dried biomass is also baled for convenience. As mentioned above, the dried biomass may be formed into bricks or blocks.

FIG. 17 depicts an alternative to the biomass waste drying unit shown in FIG. 16. In this unit 751 shown in FIG. 17, the biomass waste 753 is fed from the infeed hopper 755 into the feed chamber 757, whereupon the feed screw 759 pushed it into the drying chamber 761. Different from the embodiment of FIG. 16, the drying chamber 761 is heated by circulating a portion of the exhaust 771 from the SOFC directly into the unit through inlet 763. After circulating in the drying chamber, the SOFC exhaust exits the drying chamber through outlet 767, whereupon it moves to another part of the overall system. Naturally, the temperature of the SOFC, by this point in the system, is not so hot that it would cause combustion of the biomass waste. Fans or blowers may be used to increase the air flow inside the drying chamber 761.

FIG. 18 depicts a block 781 made from dried, condensed and encapsulated biomass waste. The depicted block is a simple rectangular prism. Alternatively, the block may be formed in a more complex shape, for example, to allow for interlocking of stacked and adjacent blocks.

FIG. 19 is a cross section of the block of FIG. 18. As seen, the block contains the dried and compressed biomass waste 783. In some embodiments, an inert material, such as sand or clay is mixed with the dried biomass waste in order to enhance the structural properties of the block. For example, it may be preferred for the block to have a density higher than is afforded by the dried biomass.

As shown in FIG. 19, a layer of an encapsulating polymeric film 785. The purpose of the film is add to the structural integrity of the block and to keep moisture from rehydrating the dried biomass waste. The thickness exaggerated in this FIG. 19 for convenience. Preferably, the encapsulation is accomplished with as little polymer as possible, depending on the nature of the polymer and the use to which the block may be put. Preferably, the encapsulating film is formed from a recycled polymer, most preferably by simply melting recycled plastic articles (see discussion below).

Depending on the properties sought in the finished block, the plastic may have various additives formulated into the polymer before it is used on the block. For example, it may be desirable to add an inert filler, to improve properties such as opacity and UV resistance. It may also be desirable to add dyes or pigments to achieve certain colors. It may yet be desirable to add plasticizers to increase the toughness of the film. It may still yet be desirable to add pest control ingredients, such as antimicrobials or insecticides to the film to increase the life expectancy of the block. Such formulations and additives are considered within the skill in the art.

FIG. 20 depicts dried biomass waste 791 that has been compacted and baled for convenience in handling and transporting. The mechanical means for doing such is considered within the skill in the art. Alternatively, the dried biomass may be compacted and unitized into other forms. For example, pellets are a convenient form to handle dried materials.

### Enhancing CO₂ and Other Conditions in a Greenhouse

Adding carbon dioxide (CO₂) to greenhouses is a common practice known as CO₂ enrichment or CO₂ supplementation. This technique is based on the fundamental role that CO₂ plays in photosynthesis, the process by which plants convert light energy, usually from the sun, into chemical energy to fuel their growth. By increasing the concentration of CO₂ in the greenhouse atmosphere, plants can photosynthesize more efficiently and, under certain conditions, grow faster and yield more.

In photosynthesis, plants absorb CO₂ from the air and, using the energy from light, convert it into sugars and other organic compounds, releasing oxygen in the process. Ambient CO₂ levels in the atmosphere (around 400 ppm) can sometimes be limiting for plants in a greenhouse environment, especially when the greenhouse is closed and plants have used up available CO₂. By increasing CO₂ levels to between 800-1,200 ppm, photosynthetic rates can be significantly enhanced. With more CO₂ available, plants can produce sugars at an accelerated rate, leading to faster growth. Many crops, including tomatoes, cucumbers, and peppers, often produce higher yields when grown under elevated CO₂ conditions. Elevated CO₂ can also reduce the stomatal aperture on plant leaves, leading to decreased water loss from transpiration and thus better water use efficiency. Some studies even suggest that certain crops might have improved nutritional or taste qualities under elevated CO₂.

In some conventional CO₂ enhancement systems, propane or natural gas can be burned in CO₂ generators specifically designed for greenhouses. This not only produces CO₂ but also heat, which can be advantageous in colder climates. In other convention systems, liquid CO₂ stored in pressurized tanks can be released into the greenhouse via a distribution system. though less common, CO₂ can also be produced through microbial fermentation.

In the preferred embodiment of the integrated system, the CO₂ for plant growth enhancement is provided from the exhaust of the SOFC. One advantage is that the SOFC exhaust can also be used to heat the greenhouse. In this way, a greenhouse in a cooler climate may be used to grow different, warmer climate type plants, without needing to spend resources on heating. If the greenhouse has reached its maximum CO₂ level and still needs heat, the heating systems noted above, namely radiant, forced air and heat pump systems can be used. In some embodiments, the air in the greenhouse may need cooling. If so, the heat sink or absorptive cooling, both described above, can be used for that purpose.

Since CO₂ is heavier than air, the SOFC exhaust with CO₂ is preferably released into the green house from a point above the plants, for example through ducts with outlets near the ceiling of the greenhouse. Fans are preferably used to disperse the CO₂ throughout the greenhouse.

For the safety of the workers and the health of the plants, the level of CO₂ and the temperature of the exhaust and the temperature inside the greenhouse is closely monitored. Preferably, several conventional temperature and CO₂ sensors are located throughout the greenhouse. The exhaust from the SOFC may be partially or wholy diverted away from the greenhouse if either the temperature or CO₂ levels are too high. The sensors are also preferably connected to an alarm system to warn workers of dangerous conditions within the greenhouse.

Water for the plants in the greenhouse may come from conventional sources. As shown in FIG. 1, some water may also come from vapor condensed and purified from the SOFC exhaust. Alternatively, water is provided from one or more of the systems noted above. For example, if it meets appropriate standards, the gray water recovered in the hydrothermal carbonization unit may be used to water the plant.

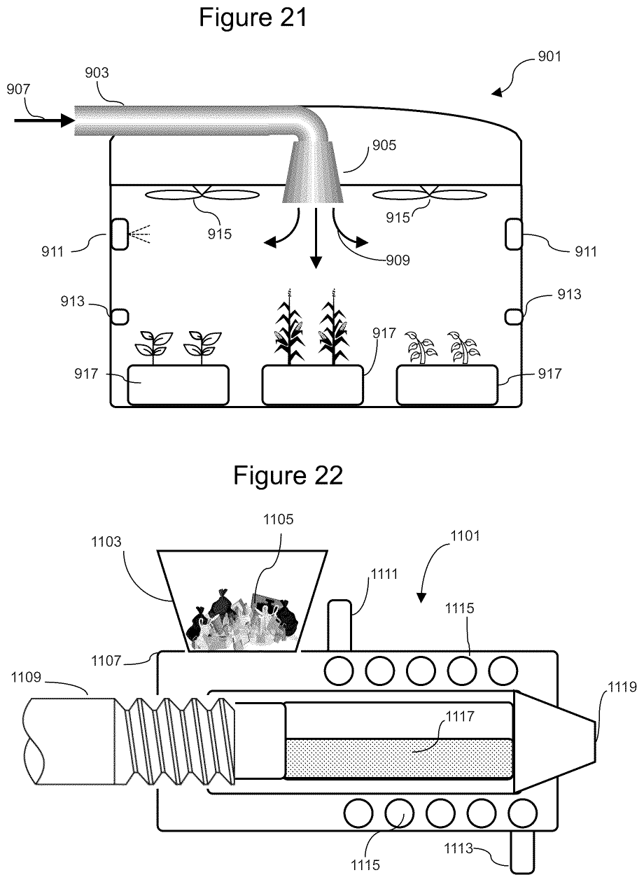

FIG. 21 depicts a simplified greenhouse 901 that uses exhaust from the SOFC to provide CO₂ enhancement and heat when needed. As shown, exhaust 907 from the SOFC enters through a duct 903 and through a diffuser/spreader 905 so the exhaust streams 909 are introduced to the interior of the greenhouse. Overhead fans 915 are used when needed to disperse the exhaust throughout the greenhouse. The plants are grown in planters 917.

Multi-sensors 913 are placed through the greenhouse to monitor the CO₂ levels and temperatures within the greenhouse, to ensure safety of personnel and to provide optimum growing conditions for the plants. Preferably, the multi-sensors communicate with a control system that automatically increases or reduces the amount of SOFC exhaust or cuts off completely the SOFC exhaust entering the greenhouse. If the control system detects that the greenhouse is warm enough, but still needs addition CO₂ for optimum growing, the system may cool the SOFC exhaust by drawing in fresh air. In that way, CO₂ from the exhaust is provided, without extra heat.

If an unsafe condition is detected, warning lights and speakers 911 are activated to alert any personnel to vacate the greenhouse. The control system may also automatically open doors or windows and activate fans to ventilate the greenhouse.

The greenhouse in the system should be located close enough for practical transport of the SOFC exhaust to the greenhouse. Fans or blowers are preferably used to facilitate this transport. In one embodiment, the greenhouse is located on top of the complex.

The greenhouse in the system may use conventional growing of plants in beds of soil. Alternatively, the greenhouse may use hydroponics to grow at least some of the plants. As noted above, it is preferred that the food produced by the greenhouse be provided to the residents of the complex. Alternatively, the utility provider may sell the food to offset the cost of the other utilities.

As noted above, it is preferred to feed the non-food residuals from the greenhouse to the biomass waste pyrolysis unit. Preferably, these residuals are dried in the biomass waste drying unit first.

### Waste Plastics Melting

An additional unit for the system is a plastics melting unit 1101 depicted in FIG. 22. While, it may be preferable to treat waste plastic in the pyrolysis unit described above to produce biochar, it may also be preferable to process some or all of the plastic waste in this melting unit. In this way, the plastic waste can be melted for consolidation for transport, storage or subsequent processing or, more preferably, for other uses.

The unit 1101 includes a hopper 1103 for receiving waste plastic items 1105. These items are fed into the melting chamber 1107 and advanced by screw 1109. Heat is supplied to the unit by means of a heat transfer fluid, which has been heated by the SOFC exhaust, through the inlet 1111 and into the coil 1115 that encircles the chamber. The slightly cooled heat transfer fluid exits the coil 1115 through outlet 1113. In the chamber the plastic 1117 is melted. By action of the screw 1109 or other means, the melted plastic is extruded through orifice 1119.

At this point, the melted plastic may be cooled for storage or transport. In any event, the plastic waste has been consolidated, so that it takes up less room. For ease in handling, the consolidated plastic may be pelletized or put into some other convenient form.

The melted plastic may also be put to other uses. As described above, the melted plastic may be used to encapsulate blocks or bricks of dried biomass. The melted plastic itself may also be shaped into useful products, such as blocks, bricks and films. In these other products, the melted plastic may have additives, such as fillers, plasticizers and the like, added to enhance the final products made from this recycled plastic. As one preferred example, the melted plastic is filled with sand or clay and formed into blocks, useful for retaining walls, pavers and the like.

### Heat Transfer for Fluids in the System

Preferably, the system can be made more efficient by including heat transfer devices for recapturing heat added to the water and other fluids in the system. For example, the pasteurizer unit described above is more efficient when the heat used to sanitize the water is recaptured as it exits the pasteurizer.

To this end, one may use the heat transfer devices described in co-pending U.S. Patent Application filed the same day as the present application, entitled Heat Exchanger and assigned attorney docket number NDU23002P. The entire disclosure of this application is incorporated herein by reference.

It is noted that all patents and patent applications mentioned herein are incorporated in their entirety by this reference. It is also noted that the invention has been described with reference to various specific and preferred embodiments and techniques. Nevertheless, it is understood that many variations and modifications may be made while remaining within the spirit and scope of the invention.

What is claimed is:

1. A system for producing electrical energy and utilizing associated heat comprising:
a source of fuel;
a source of oxygen;
a solid oxide fuel cell configured to oxidize the fuel to create electrical energy and heat; and
at least one unit configured to utilize heat generated by the solid oxide fuel cell, the at least one unit selected from the group consisting of:
a solid waste pyrolysis unit;
a hydrothermal carbonization unit;
a water distillation unit;
a water pasteurization unit;
a water heating unit;
a room heating and cooling unit; and
a biomass drying unit.

2. The system of claim 1, comprising at least two of the units configured to utilize heat generated by the solid oxide fuel cell.

3. The system of claim 1, comprising at least three of the units configured to utilize heat generated by the solid oxide fuel cell.

4. The system of claim 1, wherein the fuel is hydrogen.

5. The system of claim 1, wherein the fuel is methane.

6. The system of claim 5, wherein at least some of the CO₂ generated by the solid oxide fuel cell is passed to a greenhouse to optimize growing of plants.

7. The system of claim 5, wherein the system comprises a solid waste pyrolysis unit adapted to pyrolyze organic waste to thereby produce biochar in sufficient quantities to sequester more carbon than is released by the methane fuel used in the solid oxide fuel cell.

8. The system of claim 1, wherein the solid oxide fuel cell generates an exhaust of hot gases and wherein the at least one unit comprise a heat exchanger that draws heat from the fuel cell exhaust of hot gases.

9. The system of claim 1, adapted to provide the electric energy used in a multi-residence complex.

10. The system of claim 9, wherein the system comprises a solid waste pyrolysis unit configured to process the waste generated by the complex.

11. The system of claim 10, wherein the system further comprises a hydrothermal carbonization unit to process blackwater generated by the complex.

12. A system for providing utilities used in a multi-residence complex, the system comprising:
a source of fuel;
a source of oxygen;
a solid oxide fuel cell configured to oxidize the fuel to create electrical energy for use in the complex, and to create heat; and
at least one unit configured to provide a utility other than electrical energy to the complex and to utilize heat generated by the solid oxide fuel cell, the at least one unit selected from the group consisting of:
a solid waste pyrolysis unit for treating solid waste generated by residents of the complex;
a hydrothermal carbonization unit for treating black water generated by residents of the complex;
a water distillation unit for distilling gray water generated by residents of the complex;
a water pasteurization unit for pasteurizing water for use in the complex;
a water heating unit for providing hot water for residents of the complex;
a room heating and cooling unit for providing heating and cooling for at least a portion of the complex; and
a biomass drying unit for drying biomass generated either by residents of the complex, by outside producers, or by both.

13. The system of claim 12, further comprising a second solid oxide fuel cell, and wherein the solid oxide fuel cell and the second solid oxide fuel cell each have a capacity to provide the electric energy to the entire complex, to thereby provide a backup power system.

14. The system of claim 12, wherein the system includes a hydrothermal carbonization that utilizes unit from the solid oxide fuel cell to treat blackwater generated by the complex.

15. The system of claim 12, wherein the system includes a solid waste pyrolysis unit that uses heat from the solid oxide fuel cell to convert solid waste generated by the complex into biochar, thus sequestering carbon.

16. The system of claim 15, wherein the fuel is methane and wherein the amount of carbon sequestered is greater than the carbon released from the methane.

17. The system of claim 15, wherein the solid waste pyrolysis unit is also supplied with solid waste generated outside the complex.

18. The system of claim 15, wherein the system comprises a biomass drying unit for drying biomass prior to pyrolysis in the solid waste pyrolysis unit.

19. The system of claim 12, wherein the system includes a heat pump driven room heating and cooling unit, and wherein a volume of water is heated by the heat from the solid oxide fuel cell to thereby provide a heat sink for the heat pump.

20. The system of claim 12, wherein the system further includes a unit for melting waste plastic items.
